(19) United States
(12) Patent Application Publication
(10) Pub. No.: US 2026/0177989 A1
(43) Pub. Date: Jun. 25, 2026

(54) BED SYSTEM AND METHOD FOR PROVIDING PERSONALIZED BEDTIME REMINDERS

(71) Applicant: Sleep Number Corporation, Minneapolis, MN (US)

(72) Inventors: Vidhya Chellamuthu, Sunnyvale, CA (US); Gary N. Garcia Molina, DeForest, WI (US)

(21) Appl. No.: 19/425,169

(22) Filed: Dec. 18, 2025

Related U.S. Application Data
(60) Provisional application No. 63/736,961, filed on Dec. 20, 2024.

(51) Int. Cl. G04G 11/00; A47C 21/04; A47C 27/08; A47C 27/10; A47C 31/12

(52) U.S. Cl. CPC G04G 11/00; A47C 21/048; A47C 27/083; A47C 31/123; A47C 27/10

(57) ABSTRACT

A controller of a bed is configured to receive one or more different types of sleep data, determine a sleep regularity factor for the user and a chronotype of the user, access, a machine learning model trained to determine a sleep onset time for the user, the machine learning model being trained based on (i) the one or more different types of sleep data including data that is representative of historic sleep times and historic wake time for the user, (ii) the sleep regularity factor of the user, and (iii) the chronotype of the user, determine e, based on an output of the machine learning model, a sleep onset time for the user, determine a target time to communicate a bedtime reminder notification to the user, and responsive to determining a target time to communicate a bedtime reminder notification to the user, communicate the bedtime reminder notification to the user.

### CROSS-REFERENCE TO RELATED APPLICATIONS

This application claims the benefit of U.S. Provisional Application Ser. No. 63/736,961, filed Dec. 20, 2024. The disclosure of the prior application is considered part of (and is incorporated by reference in) the disclosure of this application.

The present document relates to bed systems and providing sleep reminders to users of a bed system.

### BACKGROUND

In general, a bed is a piece of furniture used as a location to sleep or relax. Many modern beds include a soft mattress on a bed frame. The mattress may include springs, foam material, and/or an air chamber to support the weight of one or more occupants.

### SUMMARY

Maintaining a regular sleep schedule helps to promote longer restful sleep and higher sleep quality in a user. The present disclosure describes a process for providing a user with a notification which acts as a reminder to go to bed; providing a reminder notification can help the user adhere to their regular sleep schedule. A controller of the bed is able to collect historic data associated with a particular user's sleeps schedule, that is, data such as, sleep onset times and wake up times for the particular user. The controller can be configured to process the historic sleep data to determine a sleep onset time that aligns with the particular user's sleep schedule. The controller communicates a reminder notification to the user at the determined sleep onset time reminding the user to go to bed.

In one implementation, a system includes a bed a controller including a processor and a computer-readable memory, the controller is configured to receive, from one or more sensors, one or more different types of sleep data, the one or more different types of sleep data including data that is representative of historic sleep times and historic wake times for a user, determine, based on the data that is representative of historic sleep times and historic wake times for the user, a sleep regularity factor for the user and a chronotype of the user, access, a machine learning model that is trained to determine a sleep onset time for the user, the machine learning model being trained based on (i) the one or more different types of sleep data including data that is representative of historic sleep times and historic wake time for the user, (ii) the sleep regularity factor of the user, and (iii) the chronotype of the user, determine, based on an output of the machine learning model, a sleep onset time for the user, responsive to determining a sleep onset time for the user, determine a target time to communicate a bedtime reminder notification to the user, and responsive to determining a target time to communicate a bedtime reminder notification to the user, communicate the bedtime reminder notification to the user.

In some aspects, the techniques described herein relate to a system, wherein determining the target time to communicate the bedtime reminder notification to the user comprises accessing a machine learning model that is trained to determine a target time to communicate a bedtime reminder notification to the user.

In some aspects, the techniques described herein relate to a system, wherein determining the target time to communicate the bedtime reminder notification to the user comprises accessing a look-up table of sleep onset prediction ranges.

In some aspects, the techniques described herein relate to a system, wherein the controller is configured to communicate the bedtime reminder notification to the user by communicating an electronic message to a user device of the user.

In some aspects, the techniques described herein relate to a system, wherein the controller is configured to communicate the bedtime reminder notification to the user by communicating a push notification through a sleep application on a user device of the user.

In some aspects, the techniques described herein relate to a system, wherein the one or more sensors comprise a temperature sensor and wherein the one or more types of data include temperature data.

In some aspects, the techniques described herein relate to a system, wherein the one or more sensors comprise a pressure sensor and wherein the one or more types of data include pressure data.

In some aspects, the techniques described herein relate to a system, wherein the controller is further configured to receive additional sensor data from the one or more sensors, based on receiving additional sensor data from the one or more sensors, determine whether the user is in the bed, and based on determining that the user is not in the bed, communicate a second notification to the user, wherein the second notification is a reminder to the user to go to bed.

In some aspects, the techniques described herein relate to a system, wherein the controller is further configured to receive additional sensor data from the one or more sensors, based on receiving additional sensor data from the one or more sensors, determine whether the user is in the bed, based on determining that the user is in the bed, determine whether the user is awake, and based on determining that the user is awake in bed, communicate a signal to adjust a parameter of the bed to a sleep preference, wherein the sleep preference is a setting of a parameter that is associated with a sleep onset time.

In some aspects, the techniques described herein relate to a system, wherein communicating the signal to adjust a sleep preference of the user comprises adjusting a pressure of the bed, adjusting a temperature of bed, adjusting an ambient temperature of a room with the bed, or adjusting any other adjustable preference.

In some aspects, the techniques described herein relate to a system, wherein determining the sleep regularity factor for the user includes determining whether the sleep regularity for the user is regular or irregular based on historic sleep data collected over a specified period of past days.

In some aspects, the techniques described herein relate to a system, wherein determining the chronotype of the user includes determining whether the user is an early chronotype, an intermediate chronotype type or a late chronotype based on sleep onset time.

In another implementation, a system includes a bed, a controller connected to the bed, and a server including a processor and a computer-readable memory, the server configured to receive data that is representative of historic sleep times and historic wake times for a user of the bed from the controller, determine, based on the data that is representative of historic sleep times and historic wake times for the user, a sleep regularity factor for the user and a chronotype of the user, train a machine learning model to determine a sleep onset time for the user based on the data that is representative of historic sleep time and historic wake times for the user, use the machine learning model to determine the sleep onset time for the user, responsive to determining a sleep onset time for the user, determine a target time to communicate a bedtime reminder notification to the user, determine that the target time to communicate the bedtime reminder notification to the user is approaching, based on determining that the target time to communicate the bedtime reminder to the user is approaching, determine whether the user is in the bed, and based on determining that the user is not in the bed, communicate the bedtime reminder notification to the user.

In some aspects, the techniques described herein relate to a system, wherein the server is configured to communicate the bedtime reminder notification to the user by communicating an electronic message to a user device of the user.

In some aspects, the techniques described herein relate to a system, wherein the server is configured to communicate the bedtime reminder notification to the user by communicating a push notification through a sleep application on a user device of the user.

In some aspects, the techniques described herein relate to a system, wherein determining the sleep regularity factor for the user includes determining whether the sleep regularity for the user is regular or irregular based on historic sleep data collected over a specified period of past days.

In some aspects, the techniques described herein relate to a system, wherein determining the chronotype of the user includes determining whether the user is an early chronotype, an intermediate chronotype type or a late chronotype based on sleep onset time.

In some aspects, the techniques described herein relate to a system, wherein the server is configured to determine the target time to communicate a bedtime reminder notification to the user using a machine learning module that is trained to identify the target time.

In some aspects, the techniques described herein relate to a system, wherein the server is configured to determine the target time to communicate a bedtime reminder notification to the user by accessing a look-up table of sleep onset prediction ranges.

In another implementation, a system includes a bed, a controller connected to the bed, and a server including a processor and a computer-readable memory, the server configured to receive data that is representative of historic sleep times and historic wake times for a user of the bed from the controller, train a machine learning model to determine a sleep onset time for the user based on the data that is representative of historic sleep times and historic wake times for the user, use the machine learning model to determine the sleep onset time for the user, responsive to determining a sleep onset time for the user, determine a target time to communicate a bedtime reminder notification to the user, determine that the target time to communicate the bedtime reminder notification to the user is approaching, based on determining that the target time to communicate the bedtime reminder to the user is approaching, determine whether the user is in the bed, based on determining that the user is in the bed, determine whether the user is awake, and based on determining that the user is awake, communicate the bedtime reminder notification to the user.

In some aspects, the techniques described herein relate to a system, wherein the server is configured to communicate the bedtime reminder notification to the user by communicating an electronic message to a user device of the user.

In some aspects, the techniques described herein relate to a system, wherein the server is configured to communicate the bedtime reminder notification to the user by communicating a push notification through a sleep application on a user device of the user.

In some aspects, the techniques described herein relate to a system, wherein receiving data that is representative of historic sleep times and historic wake times for a user of the bed comprises receiving, from one or more sensors, one or more different types of sleep data, wherein the one or more sensors include a temperature sensor and a pressure sensor, and wherein the one or more types of data include temperature data and pressure data.

In another implementation, a system includes one or more sensors for a bed, and a controller connected to the one or more sensors for the bed, the controller including a processor and a computer-readable memory, the controller configured to receive data that is representative of historic sleep times and historic wake times for a user of the bed, train a machine learning model to determine a sleep onset time for the user based on the data that is representative of historic sleep times and historic wake times for the user, use the machine learning model to determine the sleep onset time for the user, responsive to determining a sleep onset time for the user, determine a target time to communicate a bedtime reminder notification to the user, determine that the target time to communicate the bedtime reminder notification to the user is approaching, based on determining that the target time to communicate the bedtime reminder to the user is approaching, determine whether the user is in the bed, based on determining that the user is in the bed, determining whether the user is awake, and based on determining that the user is awake, communicate the bedtime reminder notification to the user.

In another implementation, a system includes one or more sensors for a bed, and a controller connected to the one or more sensors for the bed, the controller including a processor and a computer-readable memory, the controller configured to receive, from one or more sensors, one or more different types of sleep data associated with a user, determine a sleep onset time for the user, and communicate a bedtime reminder notification to the user based on the determined sleep onset time for the user.

In some aspects, the techniques described herein relate to a system, wherein determining the sleep onset time for the user comprises utilizing a machine learning model to that is trained using historic sleep on set times and historic wake times for the user.

In another implementation, a system includes one or more sensors for a bed, a controller, and a server in communication with the controller, the server including a processor and a computer-readable memory, the server configured to receive, from the one or more sensors, one or more different types of sleep data associated with a user, determine a sleep onset time for the user, and communicate a bedtime reminder notification to the user based on the determined sleep onset time for the user.

In some aspects, the techniques described herein relate to a system, wherein determining a sleep onset time for the user includes using a deterministic biomathematical model to determine the sleep onset time for the user.

Implementations can provide one or more of the following advantages. The technology of beds and home automation can be improved. A bed or user's sleep environment can take an action to mitigate the snoring of the user, improving the sleep experience of another user in the same bed. Unnecessary adjustments can be avoided, for example by determining if the other sleeper is bothered by the snoring and only taking action if the other sleeper is bothered.

Other features, aspects and potential advantages will be apparent from the accompanying description and figures.

### DESCRIPTION OF DRAWINGS

FIG. 1 shows an example air bed system.

FIG. 2 is a block diagram of an example of various components of an air bed system.

FIG. 3 shows an example environment including a bed in communication with devices located in and around a home.

FIGS. 4A and 4B are block diagrams of example data processing systems that can be associated with a bed.

FIGS. 5 and 6 are block diagrams of examples of motherboards that can be used in a data processing system that can be associated with a bed.

FIG. 7 is a block diagram of an example of a daughterboard that can be used in a data processing system that can be associated with a bed.

FIG. 8 is a block diagram of an example of a motherboard with no daughterboard that can be used in a data processing system that can be associated with a bed.

FIGS. 9A, 9B, and 9C are block diagrams of an example of a sensory array that can be used in a data processing system that can be associated with a bed.

FIG. 10 is a block diagram of an example of a control array that can be used in a data processing system that can be associated with a bed.

FIG. 11 is a block diagram of an example of using a data processing system that can be associated with a bed to automate peripherals around the bed.

FIG. 12 shows an example environment including a bed and a server.

FIG. 13 is an example process for communicating a bedtime reminder notification to a user.

FIG. 14 is an example process for communicating a bedtime reminder notification to a user based on determining that the user is not in the bed.

FIG. 15 is an example process for communicating a bedtime reminder notification to the user based on determining that the user is awake.

FIG. 16 is an example process for communicating a bedtime reminder notification to a user based on a determined sleep onset time for the user.

FIG. 17 is an example workflow for determining to send a bedtime reminder.

FIG. 18 is an example workflow for using training one or more machine learning models.

FIG. 19 is a look-up table used to determine when to communicate a bedtime reminder to the user.

FIG. 20 is a schematic diagram that shows an example of a computing device and a mobile computing device.

Like reference symbols in the various drawings indicate like elements.

### DETAILED DESCRIPTION

This document describes providing a personalized bedtime reminder notification to a user of a bed. For example, a controller at a bed can be configured to receive historic sleep data associated with the user, and based on analyzing the historic sleep data can determine a sleep onset time for the user that aligns with their historic sleep schedule; the controller then communicates a bedtime reminder notification to a user device of the user based on the determined sleep onset time.

### Example Airbed Hardware

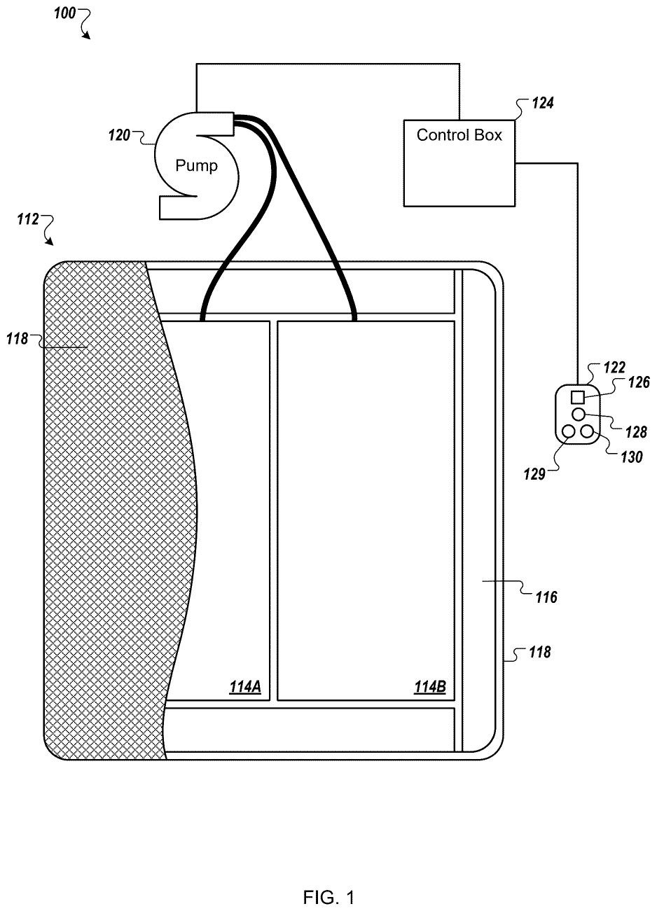

FIG. 1 shows an example air bed system 100 that includes a bed 112. The bed 112 includes at least one air chamber 114 surrounded by a resilient border 116 and encapsulated by bed ticking 118. The resilient border 116 can comprise any suitable material, such as foam.

As illustrated in FIG. 1, the bed 112 can be a two chamber design having first and second fluid chambers, such as a first air chamber 114A and a second air chamber 114B. In alternative embodiments, the bed 112 can include chambers for use with fluids other than air that are suitable for the application. In some embodiments, such as single beds or kids'beds, the bed 112 can include a single air chamber 114A or 114B or multiple air chambers 114A and 114B. First and second air chambers 114A and 114B can be in fluid communication with a pump 120. The pump 120 can be in electrical communication with a remote control 122 via control box 124. The control box 124 can include a wired or wireless communications interface for communicating with one or more devices, including the remote control 122. The control box 124 can be configured to operate the pump 120 to cause increases and decreases in the fluid pressure of the first and second air chambers 114A and 114B based upon commands input by a user using the remote control 122. In some implementations, the control box 124 is integrated into a housing of the pump 120.

The remote control 122 can include a display 126, an output selecting mechanism 128, a pressure increase button 129, and a pressure decrease button 130. The output selecting mechanism 128 can allow the user to switch air flow generated by the pump 120 between the first and second air chambers 114A and 114B, thus enabling control of multiple air chambers with a single remote control 122 and a single pump 120. For example, the output selecting mechanism 128 can by a physical control (e.g., switch or button) or an input control displayed on display 126. Alternatively, separate remote control units can be provided for each air chamber and can each include the ability to control multiple air chambers. Pressure increase and decrease buttons 129 and 130 can allow a user to increase or decrease the pressure, respectively, in the air chamber selected with the output selecting mechanism 128. Adjusting the pressure within the selected air chamber can cause a corresponding adjustment to the firmness of the respective air chamber. In some embodiments, the remote control 122 can be omitted or modified as appropriate for an application. For example, in some embodiments the bed 112 can be controlled by a computer, tablet, smart phone, or other device in wired or wireless communication with the bed 112.

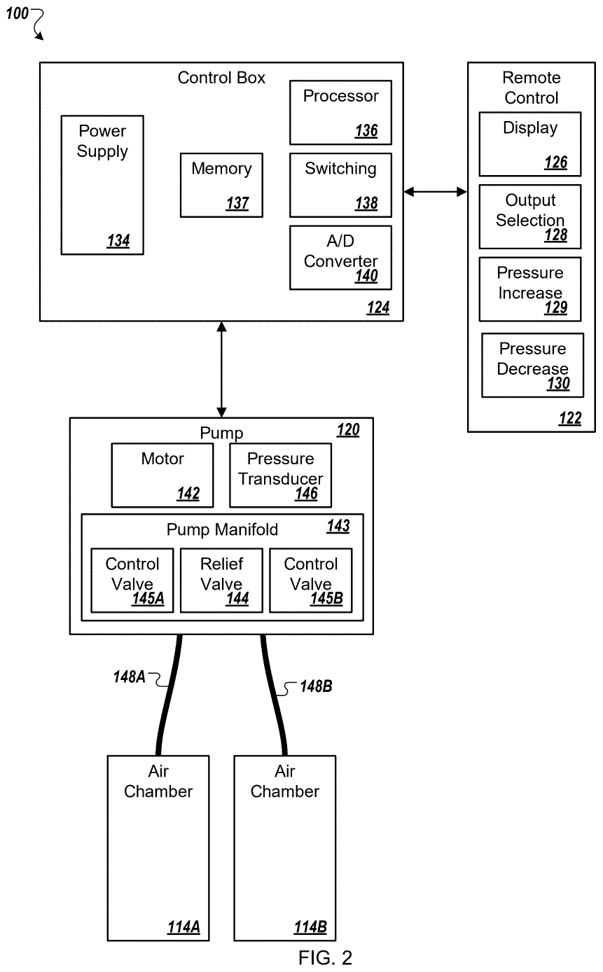

FIG. 2 is a block diagram of an example of various components of an air bed system. For example, these components can be used in the example air bed system 100. As shown in FIG. 2, the control box 124 can include a power supply 134, a processor 136, a memory 137, a switching mechanism 138, and an analog to digital (A/D) converter 140. The switching mechanism 138 can be, for example, a relay or a solid state switch. In some implementations, the switching mechanism 138 can be located in the pump 120 rather than the control box 124.

The pump 120 and the remote control 122 are in two-way communication with the control box 124. The pump 120 includes a motor 142, a pump manifold 143, a relief valve 144, a first control valve 145A, a second control valve 145B, and a pressure transducer 146. The pump 120 is fluidly connected with the first air chamber 114A and the second air chamber 114B via a first tube 148A and a second tube 148B, respectively. The first and second control valves 145A and 145B can be controlled by switching mechanism 138, and are operable to regulate the flow of fluid between the pump 120 and first and second air chambers 114A and 114B, respectively.

In some implementations, the pump 120 and the control box 124 can be provided and packaged as a single unit. In some alternative implementations, the pump 120 and the control box 124 can be provided as physically separate units. In some implementations, the control box 124, the pump 120, or both are integrated within or otherwise contained within a bed frame or bed support structure that supports the bed 112. In some implementations, the control box 124, the pump 120, or both are located outside of a bed frame or bed support structure (as shown in the example in FIG. 1).

The example air bed system 100 depicted in FIG. 2 includes the two air chambers 114A and 114B and the single pump 120. However, other implementations can include an air bed system having two or more air chambers and one or more pumps incorporated into the air bed system to control the air chambers. For example, a separate pump can be associated with each air chamber of the air bed system or a pump can be associated with multiple chambers of the air bed system. Separate pumps can allow each air chamber to be inflated or deflated independently and simultaneously. Furthermore, additional pressure transducers can also be incorporated into the air bed system such that, for example, a separate pressure transducer can be associated with each air chamber.

In use, the processor 136 can, for example, send a decrease pressure command to one of air chambers 114A or 114B, and the switching mechanism 138 can be used to convert the low voltage command signals sent by the processor 136 to higher operating voltages sufficient to operate the relief valve 144 of the pump 120 and open the control valve 145A or 145B. Opening the relief valve 144 can allow air to escape from the air chamber 114A or 114B through the respective air tube 148A or 148B. During deflation, the pressure transducer 146 can send pressure readings to the processor 136 via the A/D converter 140. The A/D converter 140 can receive analog information from pressure transducer 146 and can convert the analog information to digital information useable by the processor 136. The processor 136 can send the digital signal to the remote control 122 to update the display 126 in order to convey the pressure information to the user.

As another example, the processor 136 can send an increase pressure command. The pump motor 142 can be energized in response to the increase pressure command and send air to the designated one of the air chambers 114A or 114B through the air tube 148A or 148B via electronically operating the corresponding valve 145A or 145B. While air is being delivered to the designated air chamber 114A or 114B in order to increase the firmness of the chamber, the pressure transducer 146 can sense pressure within the pump manifold 143. Again, the pressure transducer 146 can send pressure readings to the processor 136 via the A/D converter 140. The processor 136 can use the information received from the A/D converter 140 to determine the difference between the actual pressure in air chamber 114A or 114B and the desired pressure. The processor 136 can send the digital signal to the remote control 122 to update display 126 in order to convey the pressure information to the user.

Generally speaking, during an inflation or deflation process, the pressure sensed within the pump manifold 143 can provide an approximation of the pressure within the respective air chamber that is in fluid communication with the pump manifold 143. An example method of obtaining a pump manifold pressure reading that is substantially equivalent to the actual pressure within an air chamber includes turning off pump 120, allowing the pressure within the air chamber 114A or 114B and the pump manifold 143 to equalize, and then sensing the pressure within the pump manifold 143 with the pressure transducer 146. Thus, providing a sufficient amount of time to allow the pressures within the pump manifold 143 and chamber 114A or 114B to equalize can result in pressure readings that are accurate approximations of the actual pressure within air chamber 114A or 114B. In some implementations, the pressure of the air chambers 114A and/or 114B can be continuously monitored using multiple pressure sensors (not shown).

In some implementations, information collected by the pressure transducer 146 can be analyzed to determine various states of a person lying on the bed 112. For example, the processor 136 can use information collected by the pressure transducer 146 to determine a heart rate, a movement level, or a respiration rate for a person lying in the bed 112. For example, a user can be lying on a side of the bed 112 that includes the chamber 114A. The pressure transducer 146 can monitor fluctuations in pressure of the chamber 114A and this information can be used to determine the user's heart rate and/or respiration rate. As another example, additional processing can be performed using the collected data to determine a sleep state of the person (e.g., awake, light sleep, deep sleep). For example, the processor 136 can determine when a person falls asleep and, while asleep, the various sleep states of the person.

Additional information associated with a user of the air bed system 100 that can be determined using information collected by the pressure transducer 146 includes motion of the user, presence of the user on a surface of the bed 112, weight of the user, heart arrhythmia of the user, and apnea. Taking user presence detection for example, the pressure transducer 146 can be used to detect the user's presence on the bed 112, e.g., via a gross pressure change determination and/or via one or more of a respiration rate signal, heart rate signal, and/or other biometric signals. For example, a simple pressure detection process can identify an increase in pressure as an indication that the user is present on the bed 112. As another example, the processor 136 can determine that the user is present on the bed 112 if the detected pressure increases above a specified threshold (so as to indicate that a person or other object above a certain weight is positioned on the bed 112). As yet another example, the processor 136 can identify an increase in pressure in combination with detected slight, rhythmic fluctuations in pressure as corresponding to the user being present on the bed 112. The presence of rhythmic fluctuations can be identified as being caused by respiration or heart rhythm (or both) of the user. The detection of respiration or a heartbeat can distinguish between the user being present on the bed and another object (e.g., a suit case) being placed upon the bed.

In some implementations, fluctuations in pressure can be measured at the pump 120. For example, one or more pressure sensors can be located within one or more internal cavities of the pump 120 to detect fluctuations in pressure within the pump 120. The fluctuations in pressure detected at the pump 120 can indicate fluctuations in pressure in one or both of the chambers 114A and 114B. One or more sensors located at the pump 120 can be in fluid communication with the one or both of the chambers 114A and 114B, and the sensors can be operative to determine pressure within the chambers 114A and 114B. The control box 124 can be configured to determine at least one vital sign (e.g., heart rate, respiratory rate) based on the pressure within the chamber 114A or the chamber 114B.

In some implementations, the control box 124 can analyze a pressure signal detected by one or more pressure sensors to determine a heart rate, respiration rate, and/or other vital signs of a user lying or sitting on the chamber 114A or the chamber 114B. More specifically, when a user lies on the bed 112 positioned over the chamber 114A, each of the user's heart beats, breaths, and other movements can create a force on the bed 112 that is transmitted to the chamber 114A. As a result of the force input to the chamber 114A from the user's movement, a wave can propagate through the chamber 114A and into the pump 120. A pressure sensor located at the pump 120 can detect the wave, and thus the pressure signal output by the sensor can indicate a heart rate, respiratory rate, or other information regarding the user.

With regard to sleep state, air bed system 100 can determine a user's sleep state by using various biometric signals such as heart rate, respiration, and/or movement of the user. While the user is sleeping, the processor 136 can receive one or more of the user's biometric signals (e.g., heart rate, respiration, and motion) and determine the user's present sleep state based on the received biometric signals. In some implementations, signals indicating fluctuations in pressure in one or both of the chambers 114A and 114B can be amplified and/or filtered to allow for more precise detection of heart rate and respiratory rate.

The control box 124 can perform a pattern recognition algorithm or other calculation based on the amplified and filtered pressure signal to determine the user's heart rate and respiratory rate. For example, the algorithm or calculation can be based on assumptions that a heart rate portion of the signal has a frequency in the range of 0.5-4.0 Hz and that a respiration rate portion of the signal a has a frequency in the range of less than 1 Hz. The control box 124 can also be configured to determine other characteristics of a user based on the received pressure signal, such as blood pressure, tossing and turning movements, rolling movements, limb movements, weight, the presence or lack of presence of a user, and/or the identity of the user. Techniques for monitoring a user's sleep using heart rate information, respiration rate information, and other user information are disclosed in U.S. Patent Application Publication No. 20100170043 to Steven J. Young et al., titled “APPARATUS FOR MONITORING VITAL SIGNS,” the entire contents of which is incorporated herein by reference.

For example, the pressure transducer 146 can be used to monitor the air pressure in the chambers 114A and 114B of the bed 112. If the user on the bed 112 is not moving, the air pressure changes in the air chamber 114A or 114B can be relatively minimal, and can be attributable to respiration and/or heartbeat. When the user on the bed 112 is moving, however, the air pressure in the mattress can fluctuate by a much larger amount. Thus, the pressure signals generated by the pressure transducer 146 and received by the processor 136 can be filtered and indicated as corresponding to motion, heartbeat, or respiration.

In some implementations, rather than performing the data analysis in the control box 124 with the processor 136, a digital signal processor (DSP) can be provided to analyze the data collected by the pressure transducer 146. Alternatively, the data collected by the pressure transducer 146 could be sent to a cloud-based computing system for remote analysis.

In some implementations, the example air bed system 100 further includes a temperature controller configured to increase, decrease, or maintain the temperature of a bed, for example for the comfort of the user. For example, a pad can be placed on top of or be part of the bed 112, or can be placed on top of or be part of one or both of the chambers 114A and 114B. Air can be pushed through the pad and vented to cool off a user of the bed. Conversely, the pad can include a heating element that can be used to keep the user warm. In some implementations, the temperature controller can receive temperature readings from the pad. In some implementations, separate pads are used for the different sides of the bed 112 (e.g., corresponding to the locations of the chambers 114A and 114B) to provide for differing temperature control for the different sides of the bed.

In some implementations, the user of the air bed system 100 can use an input device, such as the remote control 122, to input a desired temperature for the surface of the bed 112 (or for a portion of the surface of the bed 112). The desired temperature can be encapsulated in a command data structure that includes the desired temperature as well as identifies the temperature controller as the desired component to be controlled. The command data structure can then be transmitted via Bluetooth or another suitable communication protocol to the processor 136. In various examples, the command data structure is encrypted before being transmitted. The temperature controller can then configure its elements to increase or decrease the temperature of the pad depending on the temperature input into remote control 122 by the user.

In some implementations, data can be transmitted from a component back to the processor 136 or to one or more display devices, such as the display 126. For example, the current temperature as determined by a sensor element of temperature controller, the pressure of the bed, the current position of the foundation or other information can be transmitted to control box 124. The control box 124 can then transmit the received information to remote control 122 where it can be displayed to the user (e.g., on the display 126).

In some implementations, the example air bed system 100 further includes an adjustable foundation and an articulation controller configured to adjust the position of a bed (e.g., the bed 112) by adjusting the adjustable foundation that supports the bed. For example, the articulation controller can adjust the bed 112 from a flat position to a position in which a head portion of a mattress of the bed is inclined upward (e.g., to facilitate a user sitting up in bed and/or watching television). In some implementations, the bed 112 includes multiple separately articulable sections. For example, portions of the bed corresponding to the locations of the chambers 114A and 114B can be articulated independently from each other, to allow one person positioned on the bed 112 surface to rest in a first position (e.g., a flat position) while a second person rests in a second position (e.g., an reclining position with the head raised at an angle from the waist). In some implementations, separate positions can be set for two different beds (e.g., two twin beds placed next to each other). The foundation of the bed 112 can include more than one zone that can be independently adjusted. The articulation controller can also be configured to provide different levels of massage to one or more users on the bed 112.

### Example of a Bed in a Bedroom Environment

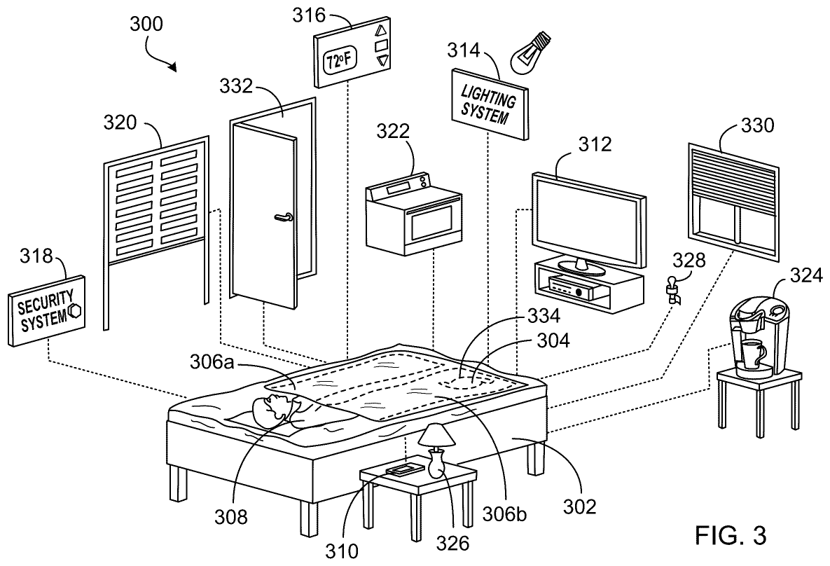

FIG. 3 shows an example environment 300 including a bed 302 in communication with devices located in and around a home. In the example shown, the bed 302 includes pump 304 for controlling air pressure within two air chambers 306a and 306b (as described above with respect to the air chambers 114A-114B). The pump 304 additionally includes circuitry for controlling inflation and deflation functionality performed by the pump 304. The circuitry is further programmed to detect fluctuations in air pressure of the air chambers 306a-b and used the detected fluctuations in air pressure to identify bed presence of a user 308, sleep state of the user 308, movement of the user 308, and biometric signals of the user 308 such as heart rate and respiration rate. In the example shown, the pump 304 is located within a support structure of the bed 302 and the control circuitry 334 for controlling the pump 304 is integrated with the pump 304. In some implementations, the control circuitry 334 is physically separate from the pump 304 and is in wireless or wired communication with the pump 304. In some implementations, the pump 304 and/or control circuitry 334 are located outside of the bed 302. In some implementations, various control functions can be performed by systems located in different physical locations. For example, circuitry for controlling actions of the pump 304 can be located within a pump casing of the pump 304 while control circuitry 334 for performing other functions associated with the bed 302 can be located in another portion of the bed 302, or external to the bed 302. As another example, control circuitry 334 located within the pump 304 can communicate with control circuitry 334 at a remote location through a LAN or WAN (e.g., the internet). As yet another example, the control circuitry 334 can be included in the control box 124 of FIGS. 1 and 2.

In some implementations, one or more devices other than, or in addition to, the pump 304 and control circuitry 334 can be utilized to identify user bed presence, sleep state, movement, and biometric signals. For example, the bed 302 can include a second pump in addition to the pump 304, with each of the two pumps connected to a respective one of the air chambers 306a-b. For example, the pump 304 can be in fluid communication with the air chamber 306b to control inflation and deflation of the air chamber 306b as well as detect user signals for a user located over the air chamber 306b such as bed presence, sleep state, movement, and biometric signals while the second pump is in fluid communication with the air chamber 306a to control inflation and deflation of the air chamber 306a as well as detect user signals for a user located over the air chamber 306a.

As another example, the bed 302 can include one or more pressure sensitive pads or surface portions that are operable to detect movement, including user presence, user motion, respiration, and heart rate. For example, a first pressure sensitive pad can be incorporated into a surface of the bed 302 over a left portion of the bed 302, where a first user would normally be located during sleep, and a second pressure sensitive pad can be incorporated into the surface of the bed 302 over a right portion of the bed 302, where a second user would normally be located during sleep. The movement detected by the one or more pressure sensitive pads or surface portions can be used by control circuitry 334 to identify user sleep state, bed presence, or biometric signals.

In some implementations, information detected by the bed (e.g., motion information) is processed by control circuitry 334 (e.g., control circuitry 334 integrated with the pump 304) and provided to one or more user devices such as a user device 310 for presentation to the user 308 or to other users. In the example depicted in FIG. 3, the user device 310 is a tablet device; however, in some implementations, the user device 310 can be a personal computer, a smart phone, a smart television (e.g., a television 312), or other user device capable of wired or wireless communication with the control circuitry 334. The user device 310 can be in communication with control circuitry 334 of the bed 302 through a network or through direct point-to-point communication. For example, the control circuitry 334 can be connected to a LAN (e.g., through a Wi-Fi router) and communicate with the user device 310 through the LAN. As another example, the control circuitry 334 and the user device 310 can both connect to the Internet and communicate through the Internet. For example, the control circuitry 334 can connect to the Internet through a WiFi router and the user device 310 can connect to the Internet through communication with a cellular communication system. As another example, the control circuitry 334 can communicate directly with the user device 310 through a wireless communication protocol such as Bluetooth. As yet another example, the control circuitry 334 can communicate with the user device 310 through a wireless communication protocol such as ZigBee, Z-Wave, infrared, or another wireless communication protocol suitable for the application. As another example, the control circuitry 334 can communicate with the user device 310 through a wired connection such as, for example, a USB connector, serial/RS232, or another wired connection suitable for the application.

The user device 310 can display a variety of information and statistics related to sleep, or user 308's interaction with the bed 302. For example, a user interface displayed by the user device 310 can present information including amount of sleep for the user 308 over a period of time (e.g., a single evening, a week, a month, etc.) amount of deep sleep, ratio of deep sleep to restless sleep, time lapse between the user 308 getting into bed and the user 308 falling asleep, total amount of time spent in the bed 302 for a given period of time, heart rate for the user 308 over a period of time, respiration rate for the user 308 over a period of time, or other information related to user interaction with the bed 302 by the user 308 or one or more other users of the bed 302. In some implementations, information for multiple users can be presented on the user device 310, for example information for a first user positioned over the air chamber 306a can be presented along with information for a second user positioned over the air chamber 306b. In some implementations, the information presented on the user device 310 can vary according to the age of the user 308. For example, the information presented on the user device 310 can evolve with the age of the user 308 such that different information is presented on the user device 310 as the user 308 ages as a child or an adult.

The user device 310 can also be used as an interface for the control circuitry 334 of the bed 302 to allow the user 308 to enter information. The information entered by the user 308 can be used by the control circuitry 334 to provide better information to the user or to various control signals for controlling functions of the bed 302 or other devices. For example, the user can enter information such as weight, height, and age and the control circuitry 334 can use this information to provide the user 308 with a comparison of the user's tracked sleep information to sleep information of other people having similar weights, heights, and/or ages as the user 308. As another example, the user 308 can use the user device 310 as an interface for controlling air pressure of the air chambers 306a and 306b, for controlling various recline or incline positions of the bed 302, for controlling temperature of one or more surface temperature control devices of the bed 302, or for allowing the control circuitry 334 to generate control signals for other devices (as described in greater detail below).

In some implementations, control circuitry 334 of the bed 302 (e.g., control circuitry 334 integrated into the pump 304) can communicate with other first, second, or third party devices or systems in addition to or instead of the user device 310. For example, the control circuitry 334 can communicate with the television 312, a lighting system 314, a thermostat 316, a security system 318, or other house hold devices such as an oven 322, a coffee maker 324, a lamp 326, and a nightlight 328. Other examples of devices and/or systems that the control circuitry 334 can communicate with include a system for controlling window blinds 330, one or more devices for detecting or controlling the states of one or more doors 332 (such as detecting if a door is open, detecting if a door is locked, or automatically locking a door), and a system for controlling a garage door 320 (e.g., control circuitry 334 integrated with a garage door opener for identifying an open or closed state of the garage door 320 and for causing the garage door opener to open or close the garage door 320). Communications between the control circuitry 334 of the bed 302 and other devices can occur through a network (e.g., a LAN or the Internet) or as point-to-point communication (e.g., using Bluetooth, radio communication, or a wired connection). In some implementations, control circuitry 334 of different beds 302 can communicate with different sets of devices. For example, a kid bed may not communicate with and/or control the same devices as an adult bed. In some embodiments, the bed 302 can evolve with the age of the user such that the control circuitry 334 of the bed 302 communicates with different devices as a function of age of the user.

The control circuitry 334 can receive information and inputs from other devices/systems and use the received information and inputs to control actions of the bed 302 or other devices. For example, the control circuitry 334 can receive information from the thermostat 316 indicating a current environmental temperature for a house or room in which the bed 302 is located. The control circuitry 334 can use the received information (along with other information) to determine if a temperature of all or a portion of the surface of the bed 302 should be raised or lowered. The control circuitry 334 can then cause a heating or cooling mechanism of the bed 302 to raise or lower the temperature of the surface of the bed 302. For example, the user 308 can indicate a desired sleeping temperature of 74 degrees while a second user of the bed 302 indicates a desired sleeping temperature of 72 degrees. The thermostat 316 can indicate to the control circuitry 334 that the current temperature of the bedroom is 72 degrees. The control circuitry 334 can identify that the user 308 has indicated a desired sleeping temperature of 74 degrees, and send control signals to a heating pad located on the user 308's side of the bed to raise the temperature of the portion of the surface of the bed 302 where the user 308 is located to raise the temperature of the user 308's sleeping surface to the desired temperature.

The control circuitry 334 can also generate control signals controlling other devices and propagate the control signals to the other devices. In some implementations, the control signals are generated based on information collected by the control circuitry 334, including information related to user interaction with the bed 302 by the user 308 and/or one or more other users. In some implementations, information collected from one or more other devices other than the bed 302 are used when generating the control signals. For example, information relating to environmental occurrences (e.g., environmental temperature, environmental noise level, and environmental light level), time of day, time of year, day of the week, or other information can be used when generating control signals for various devices in communication with the control circuitry 334 of the bed 302. For example, information on the time of day can be combined with information relating to movement and bed presence of the user 308 to generate control signals for the lighting system 314. In some implementations, rather than or in addition to providing control signals for one or more other devices, the control circuitry 334 can provide collected information (e.g., information related to user movement, bed presence, sleep state, or biometric signals for the user 308) to one or more other devices to allow the one or more other devices to utilize the collected information when generating control signals. For example, control circuitry 334 of the bed 302 can provide information relating to user interactions with the bed 302 by the user 308 to a central controller (not shown) that can use the provided information to generate control signals for various devices, including the bed 302.

Still referring to FIG. 3, the control circuitry 334 of the bed 302 can generate control signals for controlling actions of other devices, and transmit the control signals to the other devices in response to information collected by the control circuitry 334, including bed presence of the user 308, sleep state of the user 308, and other factors. For example, control circuitry 334 integrated with the pump 304 can detect a feature of a mattress of the bed 302, such as an increase in pressure in the air chamber 306b, and use this detected increase in air pressure to determine that the user 308 is present on the bed 302. In some implementations, the control circuitry 334 can identify a heart rate or respiratory rate for the user 308 to identify that the increase in pressure is due to a person sitting, laying, or otherwise resting on the bed 302 rather than an inanimate object (such as a suitcase) having been placed on the bed 302. In some implementations, the information indicating user bed presence is combined with other information to identify a current or future likely state for the user 308. For example, a detected user bed presence at 11:00 am can indicate that the user is sitting on the bed (e.g., to tie her shoes, or to read a book) and does not intend to go to sleep, while a detected user bed presence at 10:00 pm can indicate that the user 308 is in bed for the evening and is intending to fall asleep soon. As another example, if the control circuitry 334 detects that the user 308 has left the bed 302 at 6:30 am (e.g., indicating that the user 308 has woken up for the day), and then later detects user bed presence of the user 308 at 7:30 am, the control circuitry 334 can use this information that the newly detected user bed presence is likely temporary (e.g., while the user 308 ties her shoes before heading to work) rather than an indication that the user 308 is intending to stay on the bed 302 for an extended period.

In some implementations, the control circuitry 334 is able to use collected information (including information related to user interaction with the bed 302 by the user 308, as well as environmental information, time information, and input received from the user) to identify use patterns for the user 308. For example, the control circuitry 334 can use information indicating bed presence and sleep states for the user 308 collected over a period of time to identify a sleep pattern for the user. For example, the control circuitry 334 can identify that the user 308 generally goes to bed between 9:30 pm and 10:00 pm, generally falls asleep between 10:00 pm and 11:00 pm, and generally wakes up between 6:30 am and 6:45 am based on information indicating user presence and biometrics for the user 308 collected over a week. The control circuitry 334 can use identified patterns for a user to better process and identify user interactions with the bed 302 by the user 308.

For example, given the above example user bed presence, sleep, and wake patterns for the user 308, if the user 308 is detected as being on the bed at 3:00 pm, the control circuitry 334 can determine that the user's presence on the bed is only temporary, and use this determination to generate different control signals than would be generated if the control circuitry 334 determined that the user 308 was in bed for the evening. As another example, if the control circuitry 334 detects that the user 308 has gotten out of bed at 3:00 am, the control circuitry 334 can use identified patterns for the user 308 to determine that the user has only gotten up temporarily (for example, to use the rest room, or get a glass of water) and is not up for the day. By contrast, if the control circuitry 334 identifies that the user 308 has gotten out of the bed 302 at 6:40 am, the control circuitry 334 can determine that the user is up for the day and generate a different set of control signals than those that would be generated if it were determined that the user 308 were only getting out of bed temporarily (as would be the case when the user 308 gets out of the bed 302 at 3:00 am). For other users 308, getting out of the bed 302 at 3:00 am can be the normal wake-up time, which the control circuitry 334 can learn and respond to accordingly.

As described above, the control circuitry 334 for the bed 302 can generate control signals for control functions of various other devices. The control signals can be generated, at least in part, based on detected interactions by the user 308 with the bed 302, as well as other information including time, date, temperature, etc. For example, the control circuitry 334 can communicate with the television 312, receive information from the television 312, and generate control signals for controlling functions of the television 312. For example, the control circuitry 334 can receive an indication from the television 312 that the television 312 is currently on. If the television 312 is located in a different room from the bed 302, the control circuitry 334 can generate a control signal to turn the television 312 off upon making a determination that the user 308 has gone to bed for the evening. For example, if bed presence of the user 308 on the bed 302 is detected during a particular time range (e.g., between 8:00 pm and 7:00 am) and persists for longer than a threshold period of time (e.g., 10 minutes) the control circuitry 334 can use this information to determine that the user 308 is in bed for the evening. If the television 312 is on (as indicated by communications received by the control circuitry 334 of the bed 302 from the television 312) the control circuitry 334 can generate a control signal to turn the television 312 off. The control signals can then be transmitted to the television (e.g., through a directed communication link between the television 312 and the control circuitry 334 or through a network). As another example, rather than turning off the television 312 in response to detection of user bed presence, the control circuitry 334 can generate a control signal that causes the volume of the television 312 to be lowered by a pre-specified amount.

As another example, upon detecting that the user 308 has left the bed 302 during a specified time range (e.g., between 6:00 am and 8:00 am) the control circuitry 334 can generate control signals to cause the television 312 to turn on and tune to a pre-specified channel (e.g., the user 308 has indicated a preference for watching the morning news upon getting out of bed in the morning). The control circuitry 334 can generate the control signal and transmit the signal to the television 312 to cause the television 312 to turn on and tune to the desired station (which could be stored at the control circuitry 334, the television 312, or another location). As another example, upon detecting that the user 308 has gotten up for the day, the control circuitry 334 can generate and transmit control signals to cause the television 312 to turn on and begin playing a previously recorded program from a digital video recorder (DVR) in communication with the television 312.

As another example, if the television 312 is in the same room as the bed 302, the control circuitry 334 does not cause the television 312 to turn off in response to detection of user bed presence. Rather, the control circuitry 334 can generate and transmit control signals to cause the television 312 to turn off in response to determining that the user 308 is asleep. For example, the control circuitry 334 can monitor biometric signals of the user 308 (e.g., motion, heart rate, respiration rate) to determine that the user 308 has fallen asleep. Upon detecting that the user 308 is sleeping, the control circuitry 334 generates and transmits a control signal to turn the television 312 off. As another example, the control circuitry 334 can generate the control signal to turn off the television 312 after a threshold period of time after the user 308 has fallen asleep (e.g., 10 minutes after the user has fallen asleep). As another example, the control circuitry 334 generates control signals to lower the volume of the television 312 after determining that the user 308 is asleep. As yet another example, the control circuitry 334 generates and transmits a control signal to cause the television to gradually lower in volume over a period of time and then turn off in response to determining that the user 308 is asleep.

In some implementations, the control circuitry 334 can similarly interact with other media devices, such as computers, tablets, smart phones, stereo systems, etc. For example, upon detecting that the user 308 is asleep, the control circuitry 334 can generate and transmit a control signal to the user device 310 to cause the user device 310 to turn off, or turn down the volume on a video or audio file being played by the user device 310.

The control circuitry 334 can additionally communicate with the lighting system 314, receive information from the lighting system 314, and generate control signals for controlling functions of the lighting system 314. For example, upon detecting user bed presence on the bed 302 during a certain time frame (e.g., between 8:00 pm and 7:00 am) that lasts for longer than a threshold period of time (e.g., 10 minutes) the control circuitry 334 of the bed 302 can determine that the user 308 is in bed for the evening. In response to this determination, the control circuitry 334 can generate control signals to cause lights in one or more rooms other than the room in which the bed 302 is located to switch off. The control signals can then be transmitted to the lighting system 314 and executed by the lighting system 314 to cause the lights in the indicated rooms to shut off. For example, the control circuitry 334 can generate and transmit control signals to turn off lights in all common rooms, but not in other bedrooms. As another example, the control signals generated by the control circuitry 334 can indicate that lights in all rooms other than the room in which the bed 302 is located are to be turned off, while one or more lights located outside of the house containing the bed 302 are to be turned on, in response to determining that the user 308 is in bed for the evening. Additionally, the control circuitry 334 can generate and transmit control signals to cause the nightlight 328 to turn on in response to determining user 308 bed presence or whether the user 308 is asleep. As another example, the control circuitry 334 can generate first control signals for turning off a first set of lights (e.g., lights in common rooms) in response to detecting user bed presence, and second control signals for turning off a second set of lights (e.g., lights in the room in which the bed 302 is located) in response to detecting that the user 308 is asleep.

In some implementations, in response to determining that the user 308 is in bed for the evening, the control circuitry 334 of the bed 302 can generate control signals to cause the lighting system 314 to implement a sunset lighting scheme in the room in which the bed 302 is located. A sunset lighting scheme can include, for example, dimming the lights (either gradually over time, or all at once) in combination with changing the color of the light in the bedroom environment, such as adding an amber hue to the lighting in the bedroom. The sunset lighting scheme can help to put the user 308 to sleep when the control circuitry 334 has determined that the user 308 is in bed for the evening.

The control circuitry 334 can also be configured to implement a sunrise lighting scheme when the user 308 wakes up in the morning. The control circuitry 334 can determine that the user 308 is awake for the day, for example, by detecting that the user 308 has gotten off of the bed 302 (i.e., is no longer present on the bed 302) during a specified time frame (e.g., between 6:00 am and 8:00 am). As another example, the control circuitry 334 can monitor movement, heart rate, respiratory rate, or other biometric signals of the user 308 to determine that the user 308 is awake even though the user 308 has not gotten out of bed. If the control circuitry 334 detects that the user is awake during a specified time frame, the control circuitry 334 can determine that the user 308 is awake for the day. The specified time frame can be, for example, based on previously recorded user bed presence information collected over a period of time (e.g., two weeks) that indicates that the user 308 usually wakes up for the day between 6:30 am and 7:30 am. In response to the control circuitry 334 determining that the user 308 is awake, the control circuitry 334 can generate control signals to cause the lighting system 314 to implement the sunrise lighting scheme in the bedroom in which the bed 302 is located. The sunrise lighting scheme can include, for example, turning on lights (e.g., the lamp 326, or other lights in the bedroom). The sunrise lighting scheme can further include gradually increasing the level of light in the room where the bed 302 is located (or in one or more other rooms). The sunrise lighting scheme can also include only turning on lights of specified colors. For example, the sunrise lighting scheme can include lighting the bedroom with blue light to gently assist the user 308 in waking up and becoming active.

In some implementations, the control circuitry 334 can generate different control signals for controlling actions of one or more components, such as the lighting system 314, depending on a time of day that user interactions with the bed 302 are detected. For example, the control circuitry 334 can use historical user interaction information for interactions between the user 308 and the bed 302 to determine that the user 308 usually falls asleep between 10:00 pm and 11:00 pm and usually wakes up between 6:30 am and 7:30 am on weekdays. The control circuitry 334 can use this information to generate a first set of control signals for controlling the lighting system 314 if the user 308 is detected as getting out of bed at 3:00am and to generate a second set of control signals for controlling the lighting system 314 if the user 308 is detected as getting out of bed after 6:30 am. For example, if the user 308 gets out of bed prior to 6:30 am, the control circuitry 334 can turn on lights that guide the user 308's route to a restroom. As another example, if the user 308 gets out of bed prior to 6:30 am, the control circuitry 334 can turn on lights that guide the user 308's route to the kitchen (which can include, for example, turning on the nightlight 328, turning on under bed lighting, or turning on the lamp 326).

As another example, if the user 308 gets out of bed after 6:30 am, the control circuitry 334 can generate control signals to cause the lighting system 314 to initiate a sunrise lighting scheme, or to turn on one or more lights in the bedroom and/or other rooms. In some implementations, if the user 308 is detected as getting out of bed prior to a specified morning rise time for the user 308, the control circuitry 334 causes the lighting system 314 to turn on lights that are dimmer than lights that are turned on by the lighting system 314 if the user 308 is detected as getting out of bed after the specified morning rise time. Causing the lighting system 314 to only turn on dim lights when the user 308 gets out of bed during the night (i.e., prior to normal rise time for the user 308) can prevent other occupants of the house from being woken by the lights while still allowing the user 308 to see in order to reach the restroom, kitchen, or another destination within the house.

The historical user interaction information for interactions between the user 308 and the bed 302 can be used to identify user sleep and awake time frames. For example, user bed presence times and sleep times can be determined for a set period of time (e.g., two weeks, a month, etc.). The control circuitry 334 can then identify a typical time range or time frame in which the user 308 goes to bed, a typical time frame for when the user 308 falls asleep, and a typical time frame for when the user 308 wakes up (and in some cases, different time frames for when the user 308 wakes up and when the user 308 actually gets out of bed). In some implementations, buffer time can be added to these time frames. For example, if the user is identified as typically going to bed between 10:00 pm and 10:30 pm, a buffer of a half hour in each direction can be added to the time frame such that any detection of the user getting onto the bed between 9:30 pm and 11:00 pm is interpreted as the user 308 going to bed for the evening. As another example, detection of bed presence of the user 308 starting from a half hour before the earliest typical time that the user 308 goes to bed extending until the typical wake up time (e.g., 6:30 am) for the user can be interpreted as the user going to bed for the evening. For example, if the user typically goes to bed between 10:00 pm and 10:30 pm, if the user's bed presence is sensed at 12:30 am one night, that can be interpreted as the user getting into bed for the evening even though this is outside of the user's typical time frame for going to bed because it has occurred prior to the user's normal wake up time. In some implementations, different time frames are identified for different times of the year (e.g., earlier bed time during winter vs. summer) or at different times of the week (e.g., user wakes up earlier on weekdays than on weekends).

The control circuitry 334 can distinguish between the user 308 going to bed for an extended period (such as for the night) as opposed to being present on the bed 302 for a shorter period (such as for a nap) by sensing duration of presence of the user 308. In some examples, the control circuitry 334 can distinguish between the user 308 going to bed for an extended period (such as for the night) as opposed to going to bed for a shorter period (such as for a nap) by sensing duration of sleep of the user 308. For example, the control circuitry 334 can set a time threshold whereby if the user 308 is sensed on the bed 302 for longer than the threshold, the user 308 is considered to have gone to bed for the night. In some examples, the threshold can be about 2 hours, whereby if the user 308 is sensed on the bed 302 for greater than 2 hours, the control circuitry 334 registers that as an extended sleep event. In other examples, the threshold can be greater than or less than two hours.

The control circuitry 334 can detect repeated extended sleep events to determine a typical bed time range of the user 308 automatically, without requiring the user 308 to enter a bed time range. This can allow the control circuitry 334 to accurately estimate when the user 308 is likely to go to bed for an extended sleep event, regardless of whether the user 308 typically goes to bed using a traditional sleep schedule or a non-traditional sleep schedule. The control circuitry 334 can then use knowledge of the bed time range of the user 308 to control one or more components (including components of the bed 302 and/or non-bed peripherals) differently based on sensing bed presence during the bed time range or outside of the bed time range.

In some examples, the control circuitry 334 can automatically determine the bed time range of the user 308 without requiring user inputs. In some examples, the control circuitry 334 can determine the bed time range of the user 308 automatically and in combination with user inputs. In some examples, the control circuitry 334 can set the bed time range directly according to user inputs. In some examples, the control circuity 334 can associate different bed times with different days of the week. In each of these examples, the control circuitry 334 can control one or more components (such as the lighting system 314, the thermostat 316, the security system 318, the oven 322, the coffee maker 324, the lamp 326, and the nightlight 328), as a function of sensed bed presence and the bed time range.

The control circuitry 334 can additionally communicate with the thermostat 316, receive information from the thermostat 316, and generate control signals for controlling functions of the thermostat 316. For example, the user 308 can indicate user preferences for different temperatures at different times, depending on the sleep state or bed presence of the user 308. For example, the user 308 may prefer an environmental temperature of 72 degrees when out of bed, 70 degrees when in bed but awake, and 68 degrees when sleeping. The control circuitry 334 of the bed 302 can detect bed presence of the user 308 in the evening and determine that the user 308 is in bed for the night. In response to this determination, the control circuitry 334 can generate control signals to cause the thermostat to change the temperature to 70 degrees. The control circuitry 334 can then transmit the control signals to the thermostat 316. Upon detecting that the user 308 is in bed during the bed time range or asleep, the control circuitry 334 can generate and transmit control signals to cause the thermostat 316 to change the temperature to 68. The next morning, upon determining that the user is awake for the day (e.g., the user 308 gets out of bed after 6:30 am) the control circuitry 334 can generate and transmit control circuitry 334 to cause the thermostat to change the temperature to 72 degrees.

In some implementations, the control circuitry 334 can similarly generate control signals to cause one or more heating or cooling elements on the surface of the bed 302 to change temperature at various times, either in response to user interaction with the bed 302 or at various pre-programmed times. For example, the control circuitry 334 can activate a heating element to raise the temperature of one side of the surface of the bed 302 to 73 degrees when it is detected that the user 308 has fallen asleep. As another example, upon determining that the user 308 is up for the day, the control circuitry 334 can turn off a heating or cooling element. As yet another example, the user 308 can pre-program various times at which the temperature at the surface of the bed should be raised or lowered. For example, the user can program the bed 302 to raise the surface temperature to 76 degrees at 10:00 pm, and lower the surface temperature to 68 degrees at 11:30 pm.

In some implementations, in response to detecting user bed presence of the user 308 and/or that the user 308 is asleep, the control circuitry 334 can cause the thermostat 316 to change the temperature in different rooms to different values. For example, in response to determining that the user 308 is in bed for the evening, the control circuitry 334 can generate and transmit control signals to cause the thermostat 316 to set the temperature in one or more bedrooms of the house to 72 degrees and set the temperature in other rooms to 67 degrees.

The control circuitry 334 can also receive temperature information from the thermostat 316 and use this temperature information to control functions of the bed 302 or other devices. For example, as discussed above, the control circuitry 334 can adjust temperatures of heating elements included in the bed 302 in response to temperature information received from the thermostat 316.

In some implementations, the control circuitry 334 can generate and transmit control signals for controlling other temperature control systems. For example, in response to determining that the user 308 is awake for the day, the control circuitry 334 can generate and transmit control signals for causing floor heating elements to activate. For example, the control circuitry 334 can cause a floor heating system for a master bedroom to turn on in response to determining that the user 308 is awake for the day.

The control circuitry 334 can additionally communicate with the security system 318, receive information from the security system 318, and generate control signals for controlling functions of the security system 318. For example, in response to detecting that the user 308 in is bed for the evening, the control circuitry 334 can generate control signals to cause the security system to engage or disengage security functions. The control circuitry 334 can then transmit the control signals to the security system 318 to cause the security system 318 to engage. As another example, the control circuitry 334 can generate and transmit control signals to cause the security system 318 to disable in response to determining that the user 308 is awake for the day (e.g., user 308 is no longer present on the bed 302 after 6:00 am). In some implementations, the control circuitry 334 can generate and transmit a first set of control signals to cause the security system 318 to engage a first set of security features in response to detecting user bed presence of the user 308, and can generate and transmit a second set of control signals to cause the security system 318 to engage a second set of security features in response to detecting that the user 308 has fallen asleep.

In some implementations, the control circuitry 334 can receive alerts from the security system 318 (and/or a cloud service associated with the security system 318) and indicate the alert to the user 308. For example, the control circuitry 334 can detect that the user 308 is in bed for the evening and in response, generate and transmit control signals to cause the security system 318 to engage or disengage. The security system can then detect a security breach (e.g., someone has opened the door 332 without entering the security code, or someone has opened a window when the security system 318 is engaged). The security system 318 can communicate the security breach to the control circuitry 334 of the bed 302. In response to receiving the communication from the security system 318, the control circuitry 334 can generate control signals to alert the user 308 to the security breach. For example, the control circuitry 334 can cause the bed 302 to vibrate. As another example, the control circuitry 334 can cause portions of the bed 302 to articulate (e.g., cause the head section to raise or lower) in order to wake the user 308 and alert the user to the security breach. As another example, the control circuitry 334 can generate and transmit control signals to cause the lamp 326 to flash on and off at regular intervals to alert the user 308 to the security breach. As another example, the control circuitry 334 can alert the user 308 of one bed 302 regarding a security breach in a bedroom of another bed, such as an open window in a kid's bedroom. As another example, the control circuitry 334 can send an alert to a garage door controller (e.g., to close and lock the door). As another example, the control circuitry 334 can send an alert for the security to be disengaged.

The control circuitry 334 can additionally generate and transmit control signals for controlling the garage door 320 and receive information indicating a state of the garage door 320 (i.e., open or closed). For example, in response to determining that the user 308 is in bed for the evening, the control circuitry 334 can generate and transmit a request to a garage door opener or another device capable of sensing if the garage door 320 is open. The control circuitry 334 can request information on the current state of the garage door 320. If the control circuitry 334 receives a response (e.g., from the garage door opener) indicating that the garage door 320 is open, the control circuitry 334 can either notify the user 308 that the garage door is open, or generate a control signal to cause the garage door opener to close the garage door 320. For example, the control circuitry 334 can send a message to the user device 310 indicating that the garage door is open. As another example, the control circuitry 334 can cause the bed 302 to vibrate. As yet another example, the control circuitry 334 can generate and transmit a control signal to cause the lighting system 314 to cause one or more lights in the bedroom to flash to alert the user 308 to check the user device 310 for an alert (in this example, an alert regarding the garage door 320 being open). Alternatively, or additionally, the control circuitry 334 can generate and transmit control signals to cause the garage door opener to close the garage door 320 in response to identifying that the user 308 is in bed for the evening and that the garage door 320 is open. In some implementations, control signals can vary depend on the age of the user 308.

The control circuitry 334 can similarly send and receive communications for controlling or receiving state information associated with the door 332 or the oven 322. For example, upon detecting that the user 308 is in bed for the evening, the control circuitry 334 can generate and transmit a request to a device or system for detecting a state of the door 332. Information returned in response to the request can indicate various states for the door 332 such as open, closed but unlocked, or closed and locked. If the door 332 is open or closed but unlocked, the control circuitry 334 can alert the user 308 to the state of the door, such as in a manner described above with reference to the garage door 320. Alternatively, or in addition to alerting the user 308, the control circuitry 334 can generate and transmit control signals to cause the door 332 to lock, or to close and lock. If the door 332 is closed and locked, the control circuitry 334 can determine that no further action is needed.

Similarly, upon detecting that the user 308 is in bed for the evening, the control circuitry 334 can generate and transmit a request to the oven 322 to request a state of the oven 322 (e.g., on or off). If the oven 322 is on, the control circuitry 334 can alert the user 308 and/or generate and transmit control signals to cause the oven 322 to turn off. If the oven is already off, the control circuitry 334 can determine that no further action is necessary. In some implementations, different alerts can be generated for different events. For example, the control circuitry 334 can cause the lamp 326 (or one or more other lights, via the lighting system 314) to flash in a first pattern if the security system 318 has detected a breach, flash in a second pattern if garage door 320 is on, flash in a third pattern if the door 332 is open, flash in a fourth pattern if the oven 322 is on, and flash in a fifth pattern if another bed has detected that a user of that bed has gotten up (e.g., that a child of the user 308 has gotten out of bed in the middle of the night as sensed by a sensor in the bed 302 of the child). Other examples of alerts that can be processed by the control circuitry 334 of the bed 302 and communicated to the user include a smoke detector detecting smoke (and communicating this detection of smoke to the control circuitry 334), a carbon monoxide tester detecting carbon monoxide, a heater malfunctioning, or an alert from any other device capable of communicating with the control circuitry 334 and detecting an occurrence that should be brought to the user 308's attention.

The control circuitry 334 can also communicate with a system or device for controlling a state of the window blinds 330. For example, in response to determining that the user 308 is in bed for the evening, the control circuitry 334 can generate and transmit control signals to cause the window blinds 330 to close. As another example, in response to determining that the user 308 is up for the day (e.g., user has gotten out of bed after 6:30 am) the control circuitry 334 can generate and transmit control signals to cause the window blinds 330 to open. By contrast, if the user 308 gets out of bed prior to a normal rise time for the user 308, the control circuitry 334 can determine that the user 308 is not awake for the day and does not generate control signals for causing the window blinds 330 to open. As yet another example, the control circuitry 334 can generate and transmit control signals that cause a first set of blinds to close in response to detecting user bed presence of the user 308 and a second set of blinds to close in response to detecting that the user 308 is asleep.

The control circuitry 334 can generate and transmit control signals for controlling functions of other household devices in response to detecting user interactions with the bed 302. For example, in response to determining that the user 308 is awake for the day, the control circuitry 334 can generate and transmit control signals to the coffee maker 324 to cause the coffee maker 324 to begin brewing coffee. As another example, the control circuitry 334 can generate and transmit control signals to the oven 322 to cause the oven to begin preheating (for users that like fresh baked bread in the morning). As another example, the control circuitry 334 can use information indicating that the user 308 is awake for the day along with information indicating that the time of year is currently winter and/or that the outside temperature is below a threshold value to generate and transmit control signals to cause a car engine block heater to turn on.

As another example, the control circuitry 334 can generate and transmit control signals to cause one or more devices to enter a sleep mode in response to detecting user bed presence of the user 308, or in response to detecting that the user 308 is asleep. For example, the control circuitry 334 can generate control signals to cause a mobile phone of the user 308 to switch into sleep mode. The control circuitry 334 can then transmit the control signals to the mobile phone. Later, upon determining that the user 308 is up for the day, the control circuitry 334 can generate and transmit control signals to cause the mobile phone to switch out of sleep mode.

In some implementations, the control circuitry 334 can communicate with one or more noise control devices. For example, upon determining that the user 308 is in bed for the evening, or that the user 308 is asleep, the control circuitry 334 can generate and transmit control signals to cause one or more noise cancelation devices to activate. The noise cancelation devices can, for example, be included as part of the bed 302 or located in the bedroom with the bed 302. As another example, upon determining that the user 308 is in bed for the evening or that the user 308 is asleep, the control circuitry 334 can generate and transmit control signals to turn the volume on, off, up, or down, for one or more sound generating devices, such as a stereo system radio, computer, tablet, etc.

Additionally, functions of the bed 302 are controlled by the control circuitry 334 in response to user interactions with the bed 302. For example, the bed 302 can include an adjustable foundation and an articulation controller configured to adjust the position of one or more portions of the bed 302 by adjusting the adjustable foundation that supports the bed. For example, the articulation controller can adjust the bed 302 from a flat position to a position in which a head portion of a mattress of the bed 302 is inclined upward (e.g., to facilitate a user sitting up in bed and/or watching television). In some implementations, the bed 302 includes multiple separately articulable sections. For example, portions of the bed corresponding to the locations of the air chambers 306a and 306b can be articulated independently from each other, to allow one person positioned on the bed 302 surface to rest in a first position (e.g., a flat position) while a second person rests in a second position (e.g., a reclining position with the head raised at an angle from the waist). In some implementations, separate positions can be set for two different beds (e.g., two twin beds placed next to each other). The foundation of the bed 302 can include more than one zone that can be independently adjusted. The articulation controller can also be configured to provide different levels of massage to one or more users on the bed 302 or to cause the bed to vibrate to communicate alerts to the user 308 as described above.

The control circuitry 334 can adjust positions (e.g., incline and decline positions for the user 308 and/or an additional user of the bed 302) in response to user interactions with the bed 302. For example, the control circuitry 334 can cause the articulation controller to adjust the bed 302 to a first recline position for the user 308 in response to sensing user bed presence for the user 308. The control circuitry 334 can cause the articulation controller to adjust the bed 302 to a second recline position (e.g., a less reclined, or flat position) in response to determining that the user 308 is asleep. As another example, the control circuitry 334 can receive a communication from the television 312 indicating that the user 308 has turned off the television 312, and in response the control circuitry 334 can cause the articulation controller to adjust the position of the bed 302 to a preferred user sleeping position (e.g., due to the user turning off the television 312 while the user 308 is in bed indicating that the user 308 wishes to go to sleep).

In some implementations, the control circuitry 334 can control the articulation controller so as to wake up one user of the bed 302 without waking another user of the bed 302. For example, the user 308 and a second user of the bed 302 can each set distinct wakeup times (e.g., 6:30 am and 7:15 am respectively). When the wakeup time for the user 308 is reached, the control circuitry 334 can cause the articulation controller to vibrate or change the position of only a side of the bed on which the user 308 is located to wake the user 308 without disturbing the second user. When the wakeup time for the second user is reached, the control circuitry 334 can cause the articulation controller to vibrate or change the position of only the side of the bed on which the second user is located. Alternatively, when the second wakeup time occurs, the control circuitry 334 can utilize other methods (such as audio alarms, or turning on the lights) to wake the second user since the user 308 is already awake and therefore will not be disturbed when the control circuitry 334 attempts to wake the second user.

Still referring to FIG. 3, the control circuitry 334 for the bed 302 can utilize information for interactions with the bed 302 by multiple users to generate control signals for controlling functions of various other devices. For example, the control circuitry 334 can wait to generate control signals for, for example, engaging the security system 318, or instructing the lighting system 314 to turn off lights in various rooms until both the user 308 and a second user are detected as being present on the bed 302. As another example, the control circuitry 334 can generate a first set of control signals to cause the lighting system 314 to turn off a first set of lights upon detecting bed presence of the user 308 and generate a second set of control signals for turning off a second set of lights in response to detecting bed presence of a second user. As another example, the control circuitry 334 can wait until it has been determined that both the user 308 and a second user are awake for the day before generating control signals to open the window blinds 330. As yet another example, in response to determining that the user 308 has left the bed and is awake for the day, but that a second user is still sleeping, the control circuitry 334 can generate and transmit a first set of control signals to cause the coffee maker 324 to begin brewing coffee, to cause the security system 318 to deactivate, to turn on the lamp 326, to turn off the nightlight 328, to cause the thermostat 316 to raise the temperature in one or more rooms to 72 degrees, and to open blinds (e.g., the window blinds 330) in rooms other than the bedroom in which the bed 302 is located. Later, in response to detecting that the second user is no longer present on the bed (or that the second user is awake) the control circuitry 334 can generate and transmit a second set of control signals to, for example, cause the lighting system 314 to turn on one or more lights in the bedroom, to cause window blinds in the bedroom to open, and to turn on the television 312 to a pre-specified channel.

### Examples of Data Processing Systems Associated With a bed

Described here are examples of systems and components that can be used for data processing tasks that are, for example, associated with a bed. In some cases, multiple examples of a particular component or group of components are presented. Some of these examples are redundant and/or mutually exclusive alternatives. Connections between components are shown as examples to illustrate possible network configurations for allowing communication between components. Different formats of connections can be used as technically needed or desired. The connections generally indicate a logical connection that can be created with any technologically feasible format. For example, a network on a motherboard can be created with a printed circuit board, wireless data connections, and/or other types of network connections. Some logical connections are not shown for clarity. For example, connections with power supplies and/or computer readable memory may not be shown for clarities sake, as many or all elements of a particular component may need to be connected to the power supplies and/or computer readable memory.

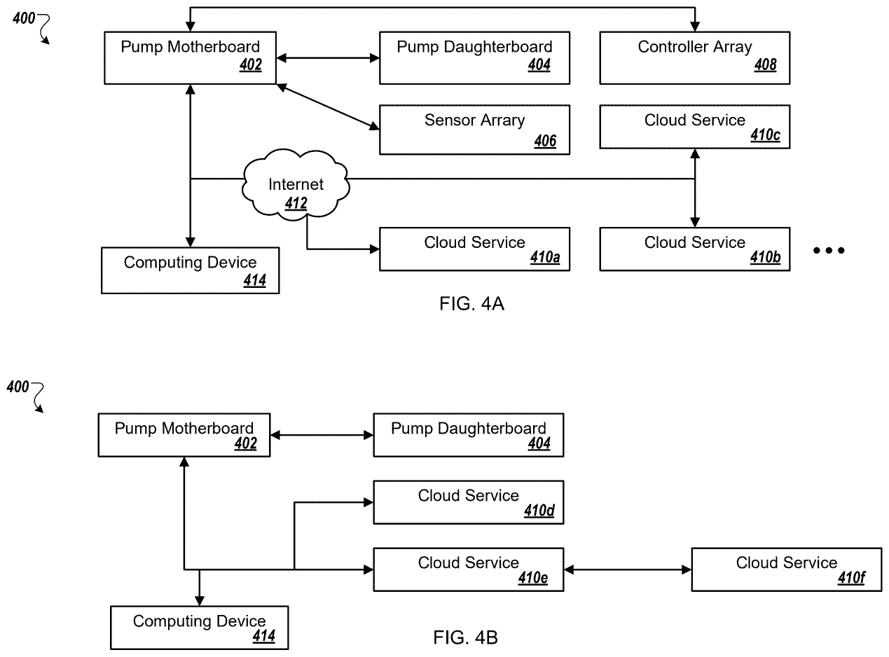

FIG. 4A is a block diagram of an example of a data processing system 400 that can be associated with a bed system, including those described above with respect to FIGS. 1-3. This system 400 includes a pump motherboard 402 and a pump daughterboard 404. The system 400 includes a sensor array 406 that can include one or more sensors configured to sense physical phenomenon of the environment and/or bed, and to report such sensing back to the pump motherboard 402 for, for example, analysis. The system 400 also includes a controller array 408 that can include one or more controllers configured to control logic-controlled devices of the bed and/or environment. The pump motherboard 400 can be in communication with one or more computing devices 414 and one or more cloud services 410 over local networks, the Internet 412, or otherwise as is technically appropriate. Each of these components will be described in more detail, some with multiple example configurations, below.

In this example, a pump motherboard 402 and a pump daughterboard 404 are communicably coupled. They can be conceptually described as a center or hub of the system 400, with the other components conceptually described as spokes of the system 400. In some configurations, this can mean that each of the spoke components communicates primarily or exclusively with the pump motherboard 402. For example, a sensor of the sensor array may not be configured to, or may not be able to, communicate directly with a corresponding controller. Instead, each spoke component can communicate with the motherboard 402. The sensor of the sensor array 406 can report a sensor reading to the motherboard 402, and the motherboard 402 can determine that, in response, a controller of the controller array 408 should adjust some parameters of a logic controlled device or otherwise modify a state of one or more peripheral devices. In one case, if the temperature of the bed is determined to be too hot, the pump motherboard 402 can determine that a temperature controller should cool the bed.

One advantage of a hub-and-spoke network configuration, sometimes also referred to as a star-shaped network, is a reduction in network traffic compared to, for example, a mesh network with dynamic routing. If a particular sensor generates a large, continuous stream of traffic, that traffic may only be transmitted over one spoke of the network to the motherboard 402. The motherboard 402 can, for example, marshal that data and condense it to a smaller data format for retransmission for storage in a cloud service 410. Additionally or alternatively, the motherboard 402 can generate a single, small, command message to be sent down a different spoke of the network in response to the large stream. For example, if the large stream of data is a pressure reading that is transmitted from the sensor array 406 a few times a second, the motherboard 402 can respond with a single command message to the controller array to increase the pressure in an air chamber. In this case, the single command message can be orders of magnitude smaller than the stream of pressure readings.

As another advantage, a hub-and-spoke network configuration can allow for an extensible network that can accommodate components being added, removed, failing, etc. This can allow, for example, more, fewer, or different sensors in the sensor array 406, controllers in the controller array 408, computing devices 414, and/or cloud services 410. For example, if a particular sensor fails or is deprecated by a newer version of the sensor, the system 400 can be configured such that only the motherboard 402 needs to be updated about the replacement sensor. This can allow, for example, product differentiation where the same motherboard 402 can support an entry level product with fewer sensors and controllers, a higher value product with more sensors and controllers, and customer personalization where a customer can add their own selected components to the system 400.

Additionally, a line of air bed products can use the system 400 with different components. In an application in which every air bed in the product line includes both a central logic unit and a pump, the motherboard 402 (and optionally the daughterboard 404) can be designed to fit within a single, universal housing. Then, for each upgrade of the product in the product line, additional sensors, controllers, cloud services, etc., can be added. Design, manufacturing, and testing time can be reduced by designing all products in a product line from this base, compared to a product line in which each product has a bespoke logic control system.

Each of the components discussed above can be realized in a wide variety of technologies and configurations. Below, some examples of each component will be further discussed. In some alternatives, two or more of the components of the system 400 can be realized in a single alternative component; some components can be realized in multiple, separate components; and/or some functionality can be provided by different components.

FIG. 4B is a block diagram showing some communication paths of the data processing system 400. As previously described, the motherboard 402 and the pump daughterboard 404 may act as a hub for peripheral devices and cloud services of the system 400. In cases in which the pump daughterboard 404 communicates with cloud services or other components, communications from the pump daughterboard 404 may be routed through the pump motherboard 402. This may allow, for example, the bed to have only a single connection with the internet 412. The computing device 414 may also have a connection to the internet 412, possibly through the same gateway used by the bed and/or possibly through a different gateway (e.g., a cell service provider).

Previously, a number of cloud services 410 were described. As shown in FIG. 4B, some cloud services, such as cloud services 410d and 410e, may be configured such that the pump motherboard 402 can communicate with the cloud service directly—that is the motherboard 402 may communicate with a cloud service 410 without having to use another cloud service 410 as an intermediary. Additionally or alternatively, some cloud services 410, for example cloud service 410f, may only be reachable by the pump motherboard 402 through an intermediary cloud service, for example cloud service 410e. While not shown here, some cloud services 410 may be reachable either directly or indirectly by the pump motherboard 402.

Additionally, some or all of the cloud services 410 may be configured to communicate with other cloud services. This communication may include the transfer of data and/or remote function calls according to any technologically appropriate format. For example, one cloud service 410 may request a copy for another cloud service's 410 data, for example, for purposes of backup, coordination, migration, or for performance of calculations or data mining. In another example, many cloud services 410 may contain data that is indexed according to specific users tracked by the user account cloud 410c and/or the bed data cloud 410a. These cloud services 410 may communicate with the user account cloud 410c and/or the bed data cloud 410a when accessing data specific to a particular user or bed.

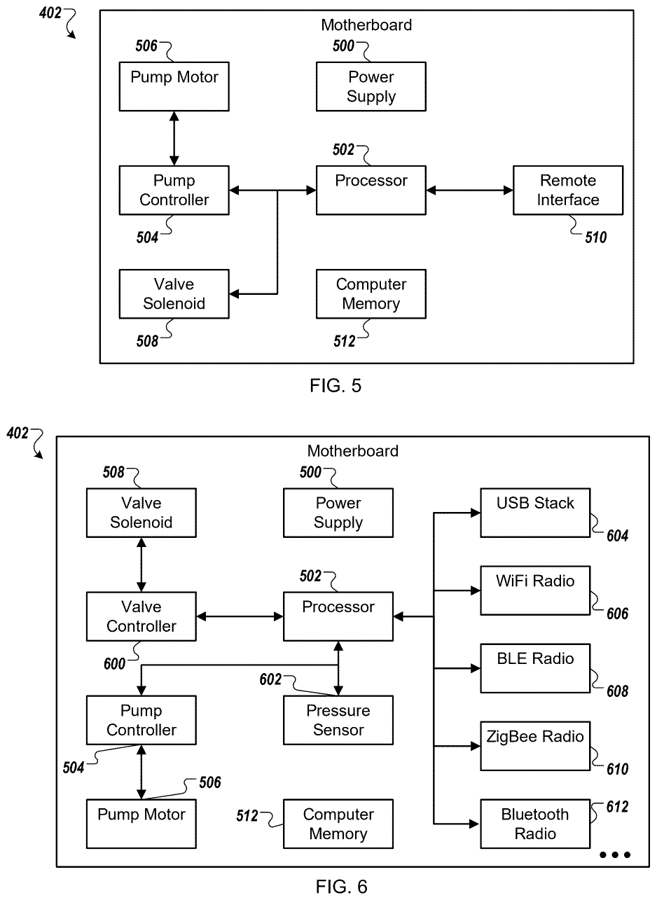

FIG. 5 is a block diagram of an example of a motherboard 402 that can be used in a data processing system that can be associated with a bed system, including those described above with respect to FIGS. 1-3. In this example, compared to other examples described below, this motherboard 402 consists of relatively fewer parts and can be limited to provide a relatively limited feature set.

The motherboard includes a power supply 500, a processor 502, and computer memory 512. In general, the power supply includes hardware used to receive electrical power from an outside source and supply it to components of the motherboard 402. The power supply can include, for example, a battery pack and/or wall outlet adapter, an AC to DC converter, a DC to AC converter, a power conditioner, a capacitor bank, and/or one or more interfaces for providing power in the current type, voltage, etc., needed by other components of the motherboard 402.

The processor 502 is generally a device for receiving input, performing logical determinations, and providing output. The processor 502 can be a central processing unit, a microprocessor, general purpose logic circuity, application-specific integrated circuity, a combination of these, and/or other hardware for performing the functionality needed.

The memory 512 is generally one or more devices for storing data. The memory 512 can include long term stable data storage (e.g., on a hard disk), short term unstable (e.g., on Random Access Memory) or any other technologically appropriate configuration.

The motherboard 402 includes a pump controller 504 and a pump motor 506. The pump controller 504 can receive commands from the processor 502 and, in response, control the function of the pump motor 506. For example, the pump controller 504 can receive, from the processor 502, a command to increase the pressure of an air chamber by 0.3 pounds per square inch (PSI). The pump controller 504, in response, engages a valve so that the pump motor 506 is configured to pump air into the selected air chamber, and can engage the pump motor 506 for a length of time that corresponds to 0.3 PSI or until a sensor indicates that pressure has been increased by 0.3 PSI. In an alternative configuration, the message can specify that the chamber should be inflated to a target PSI, and the pump controller 504 can engage the pump motor 506 until the target PSI is reached.

A valve solenoid 508 can control which air chamber a pump is connected to. In some cases, the solenoid 508 can be controlled by the processor 502 directly. In some cases, the solenoid 508 can be controlled by the pump controller 504.

A remote interface 510 of the motherboard 402 can allow the motherboard 402 to communicate with other components of a data processing system. For example, the motherboard 402 can be able to communicate with one or more daughterboards, with peripheral sensors, and/or with peripheral controllers through the remote interface 510. The remote interface 510 can provide any technologically appropriate communication interface, including but not limited to multiple communication interfaces such as WiFi, Bluetooth, and copper wired networks.

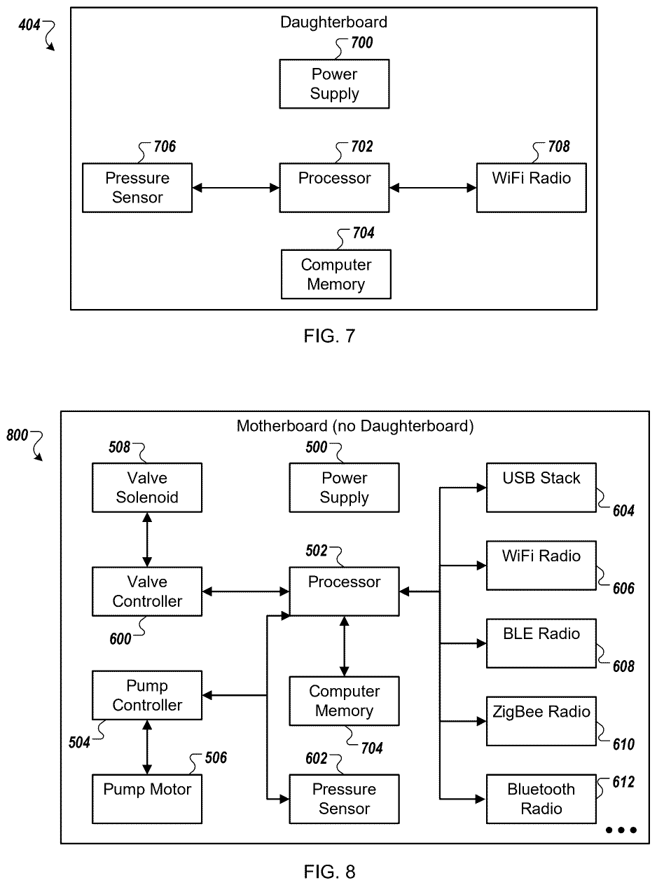

FIG. 6 is a block diagram of an example of a motherboard 402 that can be used in a data processing system that can be associated with a bed system, including those described above with respect to FIGS. 1-3. Compared to the motherboard 402 described with reference to FIG. 5, the motherboard in FIG. 6 can contain more components and provide more functionality in some applications.

In addition to the power supply 500, processor 502, pump controller 504, pump motor 506, and valve solenoid 508, this motherboard 402 is shown with a valve controller 600, a pressure sensor 602, a universal serial bus (USB) stack 604, a WiFi radio 606, a Bluetooth Low Energy (BLE) radio 608, a ZigBee radio 610, a Bluetooth radio 612 and a computer memory 512.

Similar to the way that the pump controller 504 converts commands from the processor 502 into control signals for the pump motor 506, the valve controller 600 can convert commands from the processor 502 into control signals for the valve solenoid 508. In one example, the processor 502 can issue a command to the valve controller 600 to connect the pump to a particular air chamber out of the group of air chambers in an air bed. The valve controller 600 can control the position of the valve solenoid 508 so that the pump is connected to the indicated air chamber.

The pressure sensor 602 can read pressure readings from one or more air chambers of the air bed. The pressure sensor 602 can also preform digital sensor conditioning.

The motherboard 402 can include a suite of network interfaces, including but not limited to those shown here. These network interfaces can allow the motherboard to communicate over a wired or wireless network with any number of devices, including but not limited to peripheral sensors, peripheral controllers, computing devices, and devices and services connected to the Internet 412.

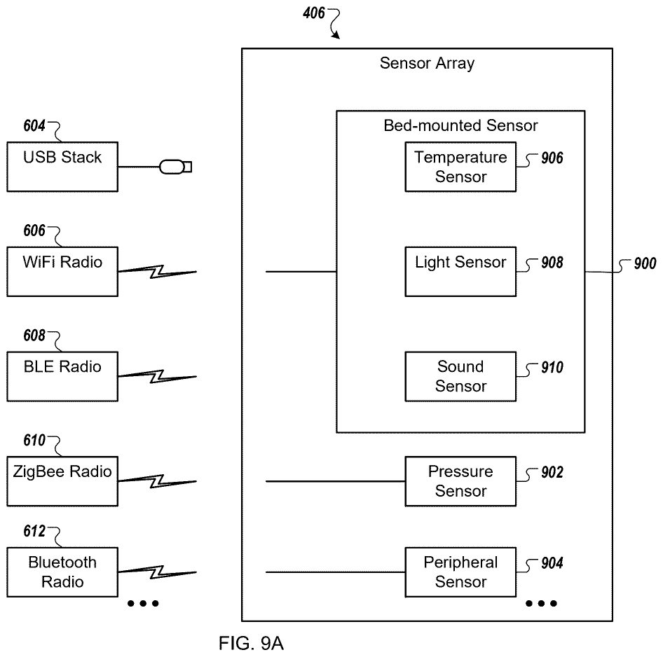

FIG. 7 is a block diagram of an example of a daughterboard 404 that can be used in a data processing system that can be associated with a bed system, including those described above with respect to FIGS. 1-3. In some configurations, one or more daughterboards 404 can be connected to the motherboard 402. Some daughterboards 404 can be designed to offload particular and/or compartmentalized tasks from the motherboard 402. This can be advantageous, for example, if the particular tasks are computationally intensive, proprietary, or subject to future revisions. For example, the daughterboard 404 can be used to calculate a particular sleep data metric. This metric can be computationally intensive, and calculating the sleep metric on the daughterboard 404 can free up the resources of the motherboard 402 while the metric is being calculated. Additionally and/or alternatively, the sleep metric can be subject to future revisions. To update the system 400 with the new sleep metric, it is possible that only the daughterboard 404 that calculates that metric need be replaced. In this case, the same motherboard 402 and other components can be used, saving the need to perform unit testing of additional components instead of just the daughterboard 404.

The daughterboard 404 is shown with a power supply 700, a processor 702, computer readable memory 704, a pressure sensor 706, and a WiFi radio 708. The processor can use the pressure sensor 706 to gather information about the pressure of the air chamber or chambers of an air bed. From this data, the processor 702 can perform an algorithm to calculate a sleep metric. In some examples, the sleep metric can be calculated from only the pressure of air chambers. In other examples, the sleep metric can be calculated from one or more other sensors. In an example in which different data is needed, the processor 702 can receive that data from an appropriate sensor or sensors. These sensors can be internal to the daughterboard 404, accessible via the WiFi radio 708, or otherwise in communication with the processor 702. Once the sleep metric is calculated, the processor 702 can report that sleep metric to, for example, the motherboard 402.

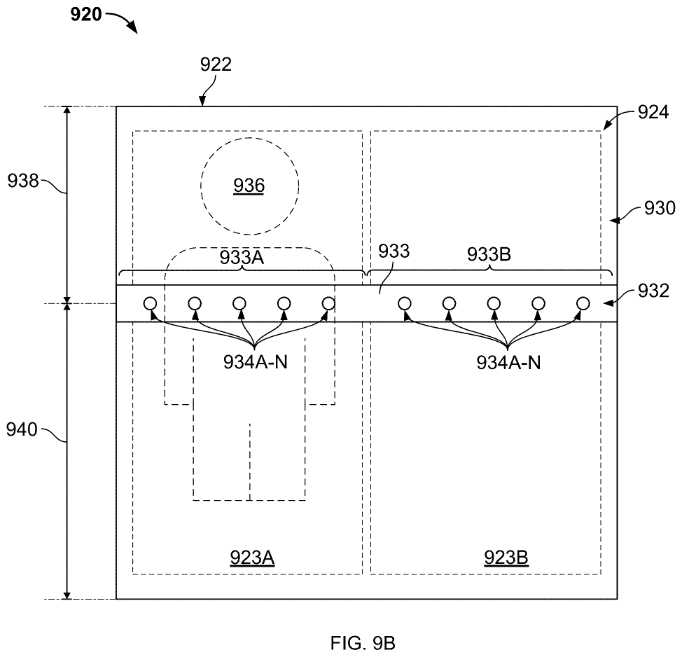

FIG. 8 is a block diagram of an example of a motherboard 800 with no daughterboard that can be used in a data processing system that can be associated with a bed system, including those described above with respect to FIGS. 1-3. In this example, the motherboard 800 can perform most, all, or more of the features described with reference to the motherboard 402 in FIG. 6 and the daughterboard 404 in FIG. 7.

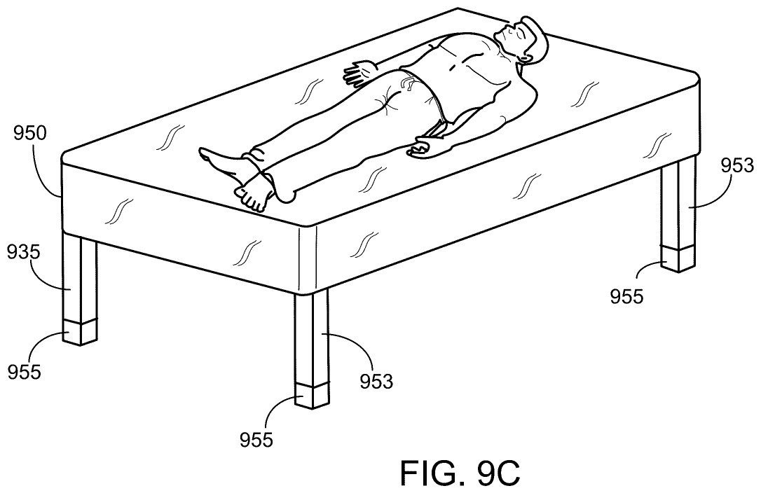

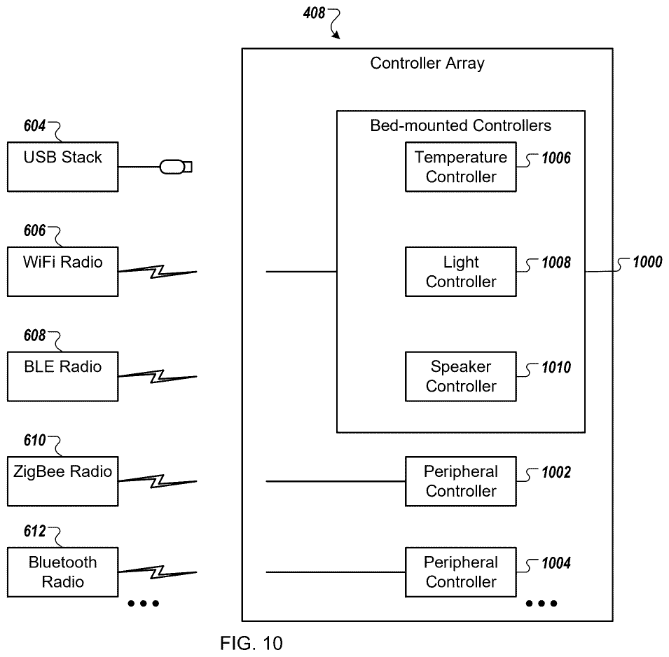

FIG. 9 is a block diagram of an example of a sensory array 406 that can be used in a data processing system that can be associated with a bed system, including those described above with respect to FIGS. 1-3. In general, the sensor array 406 is a conceptual grouping of some or all the peripheral sensors that communicate with the motherboard 402 but are not native to the motherboard 402.

The peripheral sensors of the sensor array 406 can communicate with the motherboard 402 through one or more of the network interfaces of the motherboard, including but not limited to the USB stack 604, a WiFi radio 606, a Bluetooth Low Energy (BLE) radio 608, a ZigBee radio 610, and a Bluetooth radio 612, as is appropriate for the configuration of the particular sensor. For example, a sensor that outputs a reading over a USB cable can communicate through the USB stack 604.

Some of the peripheral sensors 900 of the sensor array 406 can be bed mounted 900. These sensors can be, for example, embedded into the structure of a bed and sold with the bed, or later affixed to the structure of the bed. Other peripheral sensors 902 and 904 can be in communication with the motherboard 402, but optionally not mounted to the bed. In some cases, some or all of the bed mounted sensors 900 and/or peripheral sensors 902 and 904 can share networking hardware, including a conduit that contains wires from each sensor, a multi-wire cable or plug that, when affixed to the motherboard 402, connect all of the associated sensors with the motherboard 402. In some embodiments, one, some, or all of sensors 902, 904, 906, 908, and 910 can sense one or more features of a mattress, such as pressure, temperature, light, sound, and/or one or more other features of the mattress. In some embodiments, one, some, or all of sensors 902, 904, 906, 908, and 910 can sense one or more features external to the mattress. In some embodiments, pressure sensor 902 can sense pressure of the mattress while some or all of sensors 902, 904, 906, 908, and 910 can sense one or more features of the mattress and/or external to the mattress.

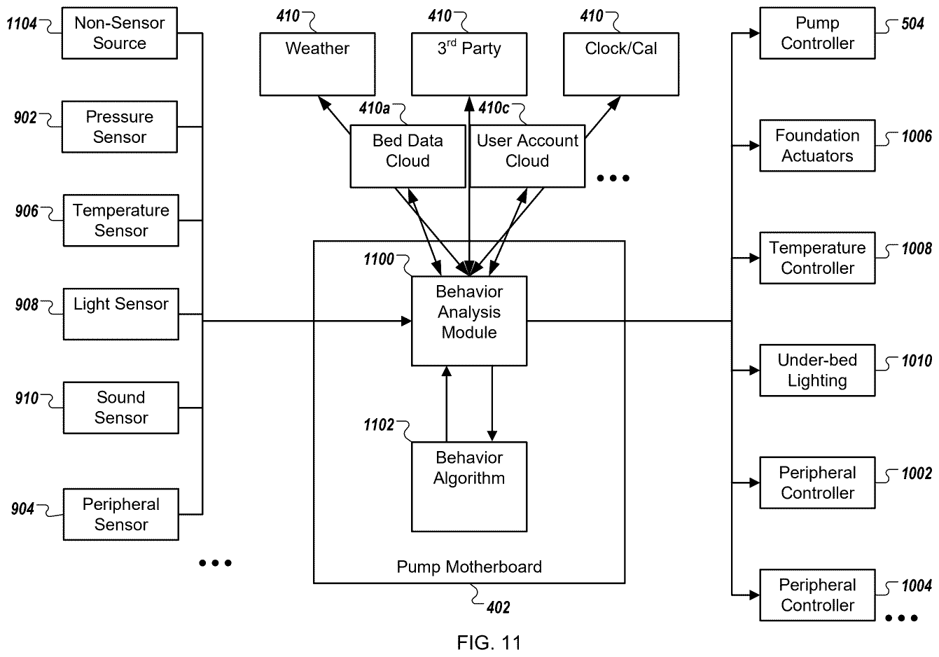

FIG. 11 is a block diagram of an example of using a data processing system that can be associated with a bed (such as a bed of the bed systems described herein) to automate peripherals around the bed. Shown here is a behavior analysis module 1100 that runs on the pump motherboard 402. For example, the behavior analysis module 1100 can be one or more software components stored on the computer memory 512 and executed by the processor 502. In general, the behavior analysis module 1100 can collect data from a wide variety of sources (e.g., sensors, non-sensor local sources, cloud data services) and use a behavioral algorithm 1102 to generate one or more actions to be taken (e.g., commands to send to peripheral controllers, data to send to cloud services). This can be useful, for example, in tracking user behavior and automating devices in communication with the user's bed.

The behavior analysis module 1100 can collect data from any technologically appropriate source, for example, to gather data about features of a bed, the bed's environment, and/or the bed's users. Some such sources include any of the sensors of the sensor array 406. For example, this data can provide the behavior analysis module 1100 with information about the current state of the environment around the bed. For example, the behavior analysis module 1100 can access readings from the pressure sensor 902 to determine the pressure of an air chamber in the bed. From this reading, and potentially other data, user presence in the bed can be determined. In another example, the behavior analysis module can access a light sensor 908 to detect the amount of light in the bed's environment.

Similarly, the behavior analysis module 1100 can access data from cloud services. For example, the behavior analysis module 1100 can access the bed cloud service 410a to access historical sensor data and/or advanced sleep data. Other cloud services 410, including those not previously described can be accessed by the behavior analysis module 1100. For example, the behavior analysis module 1100 can access a weather reporting service, a 3^{rd} party data provider (e.g., traffic and news data, emergency broadcast data, user travel data), and/or a clock and calendar service.

Similarly, the behavior analysis module 1100 can access data from non-sensor sources 1104. For example, the behavior analysis module 1100 can access a local clock and calendar service (e.g., a component of the motherboard 402 or of the processor 502).

The behavior analysis module 1100 can aggregate and prepare this data for use by one or more behavioral algorithms 1102. The behavioral algorithms 1102 can be used to learn a user's behavior and/or to perform some action based on the state of the accessed data and/or the predicted user behavior. For example, the behavior algorithm 1102 can use available data (e.g., pressure sensor, non-sensor data, clock and calendar data) to create a model of when a user goes to bed every night. Later, the same or a different behavioral algorithm 1102 can be used to determine if an increase in air chamber pressure is likely to indicate a user going to bed and, if so, send some data to a third-party cloud service 410 and/or engage a peripheral controller 1002.

In the example shown, the behavioral analysis module 1100 and the behavioral algorithm 1102 are shown as components of the motherboard 402. However, other configurations are possible. For example, the same or a similar behavioral analysis module and/or behavior algorithm can be run in one or more cloud services, and the resulting output can be sent to the motherboard 402, a controller in the controller array 408, or to any other technologically appropriate recipient.

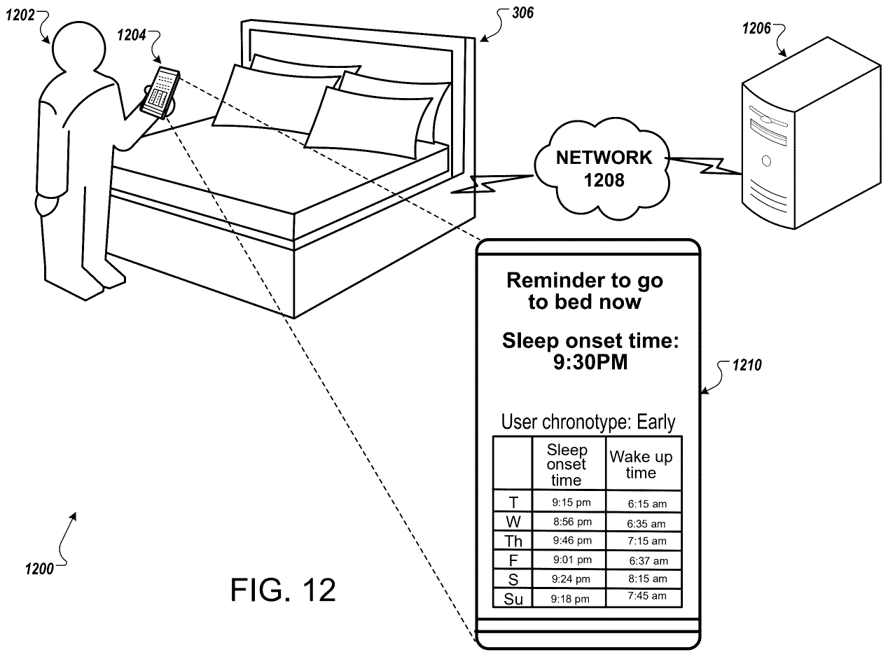

FIG. 12 shows an example environment 1200 including a bed, a user, and a server. As shown in FIG. 1, a user 1202 of a bed 306 may have a user device 1204 that is equipped with or has access to a sleep analytics application. The sleep analytics application running on or accessible on the user device 1204 may be supported by the server 1206. The sleep analytics application refers to a software/firmware program running on or accessible on the corresponding mobile device that enables the user interface and features described throughout. The network 1208 facilitates communication between elements of the system including the control box 124 at the bed 306, the server 308, and the user electronic device 1202. The user device 304 may host and display user interfaces. The user device 1202 may include a cell phone, a smart phone, a tablet PC, a personal digital assistant (“PDA”), or any other portable device configured to communicate over a network and display information.

The user 1202 may utilize the sleep analytics application on their user device 1204 to enroll in a bedtime reminder notification program. While enrolled in the bedtime reminder notification program, the user 1202 receives notifications which remind the user 1202 of their regular bedtime based on their historic sleep schedule and or habits. The user 1202 may, additionally or alternatively, receive notifications which remind the user 1202 of their preferred or desired bedtime based on, e.g., user input. The bedtime reminder notifications which are communicated to the user device 1204 of the user 1202 are communicated at a best suitable or target time based on the user's 1202 individual sleeping habits. The control box 124 at the bed 306 collects sleep data for the user 1202 over time, and processes the collected sleep data to determine an appropriate sleep onset time for the user 1202. The determined sleep onset time for the user 1202 may then be used to determine a target time (or times) to communicate the bedtime reminder notification to the user device 1204 of the user 1202. For example, a bedtime reminder notification may be sent 30 minutes prior to their regular or desired bedtime. In other implementations, one or more reminders may be sent more or less than 30 minutes prior to the user's regular or desired bedtime.

In some implementations, the sleep analytics application may be used to help a user maintain, modify, or otherwise adhere to a particular sleep schedule. the user 1202 may have the ability to set one or more sleep preference schedules through the sleep analytics application on their user device 1204. For example, the user 1202 may use the sleep analytics application to set a desired sleep onset time for 9:30 pm and sleep wake time for 5:30 am. In some examples, where the user 1202 is not currently adhering their preferred sleep schedule, the sleep analytics application may be configured to adjust provide minor step like changes to the user's sleep schedule until the user 1202 meets the desired sleep schedule. For example, the use 1202 may currently be going to sleep at 11:00 pm and waking at 8:00 am, the sleep analytics application may be configured to provide incrementally earlier bedtime reminder notifications to the user 1202 to promote the user going to sleep earlier. For example, the sleep analytics application may provide bedtime reminder notification to the user 1202, five mins earlier each night, until the user 1202 has attained their preferred/desired sleep schedule. In some implementations, the sleep analytics application may be used to help a user shift from one chronotype to another. For example, when a user 1202 is determined to be an earlier chronotype, and the user 1202 desires to shift to a late chronotype due to a change in schedule, or to respond to daylight saving time, the sleep analytics application may be configured to provide the user 1202 with one or more bedtime reminders to assist the user 1202 to adjust to the new chronotype sleep schedule.

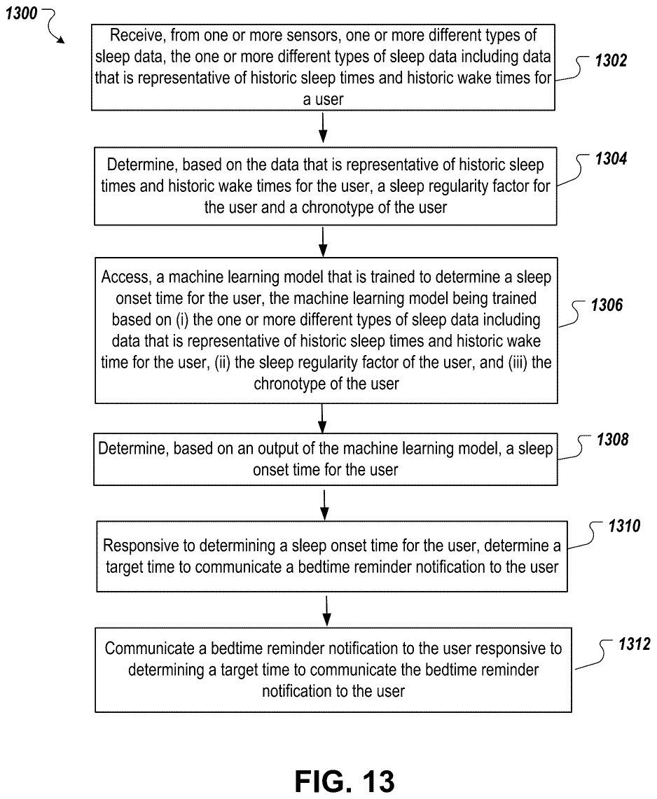

As described in more detail below, with respect to FIG. 13-17, the control box 124 at the bed 306 receives data from one or more sensors at the bed 306. The control box 124 processes and analyzes the sensor data to determine the sleep patterns of the user 1202. In some implementations, the control box 124 analyzes the data received from the bed 306 to determine a sleep regularity factor for the user 1202 and a chronotype estimation of the user 1202 based on the historic sleep onset times and historic wake up times of the user 1202. In some implementations, the control box 124 may utilize one or more machine learning models to analyze the sensor data received from the bed 306 to determine a sleep onset time for the user 1202. In some implementations, the control box 124 may utilize one or more machine learning models to determine when the bedtime reminder notification should be communicated to the user 1202. In another implementation, the control box 124 communicates the sensor data to the server 1206 for processing. In these implementations, the server 1206 may utilize one or more learning models to analyze the sensor data to determine a sleep onset time for the user 1202.

As illustrated in FIG. 12, the bedtime reminder notification 1210 that is communicated to the user 1202 may include the user's sleep onset times and wake up times over the past one or more days. For example, the notification 1210 may include the sleep onset time for Tuesday as 9:15 PM and the sleep onset time for Wednesday as 8:56 PM. The control box 124 may communicate the bedtime reminder notification 1210 to the user device 1204 of the user as a push notification through the sleep analytics application on the user device 1204.

In some implementations, the bedtime reminder notification 1210 may include the determined chronotype (sometimes called a sleep chronotype or natural preference for specific sleep and wake times) of the user 1202. For example, as illustrated in FIG. 12, the notification 1210 may include the user chronotype as an early chronotype. As described in more detail below, a chronotype is user's subjective preference for being active or sleeping at certain times of the day. A user's chronotype can be classified as a morning/early chronotype, an evening/late chronotype, or an intermediate chronotype.

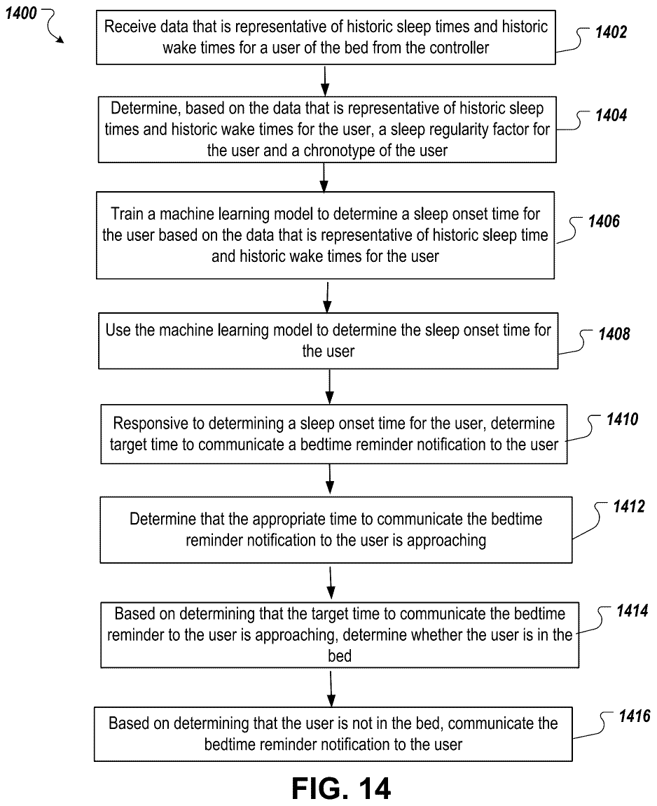

As described in greater detail below, the control box 124 may determine whether the user 1202 is in the bed 306 before communicating the bedtime reminder notification 1210 to the user's device 1204. In some implementations, the control box 124 may determine whether the user is asleep or not when it determines that the user 1202 is in the bed 306 at the target time to communicate the bedtime reminder notification 1210 to the user's device 1204. This and other implementations will be further described with respect to FIGS. 14-16 below.

FIG. 13 is a flow chart illustrating a process 1300 for communicating a bedtime reminder notification to a user. Briefly, the process 1300 may include a controller that includes a processor and a computer read-able memory, receiving, from one or more sensors, one or more different types of sleep data, the one or more different types of sleep data including data that is representative of historic sleep times and historic wake times for a user (1302), the controller determining, based on the data that is representative of historic sleep times and historic wake times for the user, a sleep regularity factor for the user and a chronotype of the user (1304), the controller accessing, a machine learning model that is trained to determine a sleep onset time for the user, the machine learning model being trained based on (i) the one or more different types of sleep data including data that is representative of historic sleep times and historic wake time for the user, (ii) the sleep regularity factor of the user, and (iii) the chronotype of the user (1306), the controller determining, based on an output of the machine learning model, a sleep onset time for the user (1308), the controller determining a target time to communicate a bedtime reminder notification to the user responsive to determining a sleep onset time for the user (1310), and the controller communicating the bedtime reminder notification to the user, responsive to determining a target time to communicate a bedtime reminder notification to the user (1312).

In more detail, process 1300 may include a controller receiving, from one or more sensors, one or more different types of sleep data, the one or more different types of sleep data including data that is representative of historic sleep times and historic wake times for a user (1302). For example, this may include the control box 124 receiving sensor data from one or more temperature sensors, one or more pressure sensors, or one or more other sensors. The sensor data, e.g., temperature data and pressure data, may be analyzed by the control box 124 to determine the state of the user 1202 in the bed 306. For example, the temperature data may be used to determine user presence in the bed 306, and the pressure data may be analyzed to determine whether the user 1202 is in the bed 306, and whether the user 1202 is asleep. The data can be used to determine the time the user 1202 fell asleep and the time the user 1202 woke up.

The process 1300 may include the controller determining, based on the data that is representative of historic sleep times and historic wake times for the user, a sleep regularity factor for the user and a chronotype of the user (1304). For example, this may include the control box 124 determining a sleep regularity factor for the user 1202. The control box 124 may calculate a sleep regularity factor to represent the consistency of a user's sleep timing. In some implementations, the sleep regularity factor may, additionally or alternatively, represent the consistency of a user's sleep duration, wake time, sleep onset, or other information. In some implementations, the control box 124 may quantify a user's sleep regularity factor using historic sleep data associated with the user 1202. For example, the user's sleep data from a period of time may be analyzed by dividing each day from the period of time into 96 fifteen-minute segments. As will be appreciated, the segments may be of any length and more or less than 96 segments may be used. Each of the segments may be labelled as a sleep segment or a wake segment based on whether the user 1202 is detected as being asleep during the segment of the day. The control box 124 then quantifies the regularity as a percentage of matching segments across all the days within the period of time. The calculated percentage may be converted into time-regularity to define two categories, regular with time-regularity that is less than 30 minutes, and irregular with time-regularity that is greater than 90 minutes. In some implementations, the regular with time-regularity may be 30 minutes or more and the irregular with time-regularity may be 90 minutes or less.

The control box 124 may determine chronotype estimation for the user 1202. A chronotype is user's preference for being active or sleeping at certain times of the day. A user's chronotype can be classified as a morning/early chronotype, an evening/late chronotype, or an intermediate chronotype. Other user chronotypes may, additionally or alternatively, be used. In some implementations, the control box 124 may use the received historic sleep and wake time data to determine an approximate chronotype of the user 1202. For example, the control box 124 may characterize a user 1202 as a morning/early chronotype when the 67^{th} percentile in time of sleep onset times of the user 1202 occurs before 10:00 pm. The control box 124 may characterize a user 1202 as an evening/late chronotype when the 67th percentile in time of sleep onset times of the user 1202 occurs after 12:00 am or later. The control box 124 may characterize a user 1202 as an intermediate chronotype when 67^{th} percentile in time of the user's sleep onset times occur between 10:00 pm and 11:59 pm. In at least one implementation, the user may provide an input or indication of their current and/or desired chronotype.

In some implementations, the control box 124 may communicate the historic sleep times and historic wake times data associated with the user 1202 to the server 1206. In these implementations, the server 1206 may use the received data to quantify the sleep regularity factor for the user 1202 and to determine the chronotype of the user 1202. In some implementations, when a user 1202 does not sleep in the bed 306, the user 1202 may manually input their sleep times and wake times through the sleep analytics application on a user device 1204 of the user 1202. The sleep analytics application may be supported by the server 1206 that is in communication with the control box 124. In some implementations, the user's sleep times and wake times may be transmitted to the server 1206 from a third party device through an application program interface (API).

The process 1300 may include the controller accessing, a machine learning model that is trained to determine a sleep onset time for the user, the machine learning model being trained based on (i) the one or more different types of sleep data including data that is representative of historic sleep times and historic wake times for the user, (ii) the sleep regularity factor of the user, and (iii) the chronotype of the user (1306). For example, this may include the control box 124 accessing a machine learning model from the server 1206 in communication with the control box 124. In some implementations, the server 1206 may generate a machine learning model that is trained to determine a sleep onset time for the user 1202. The machine learning model may be trained preferably via a supervised learning process using a large corpus of sleep data. For example, the machine learning model may be trained using historic sleep data associated with the user. In some implementations, the machine learning model may be trained via an unsupervised learning process. In these implementations, the server 1206 may utilize clustering techniques to automatically derive labels for the sleep data. In other implementations, the server 1206 may generate a machine learning model that is trained by a combination of a supervised learning process and an unsupervised learning process. In these implementations, the server 1206 may utilize the unsupervised learning process to learn the underlying probability densities functions, and may utilize the supervised learning process to fine tune the parameters of the sleep data. In some implementations, the control box 124 may generate a machine learning model that is trained to determine a sleep onset time for the user 1202.

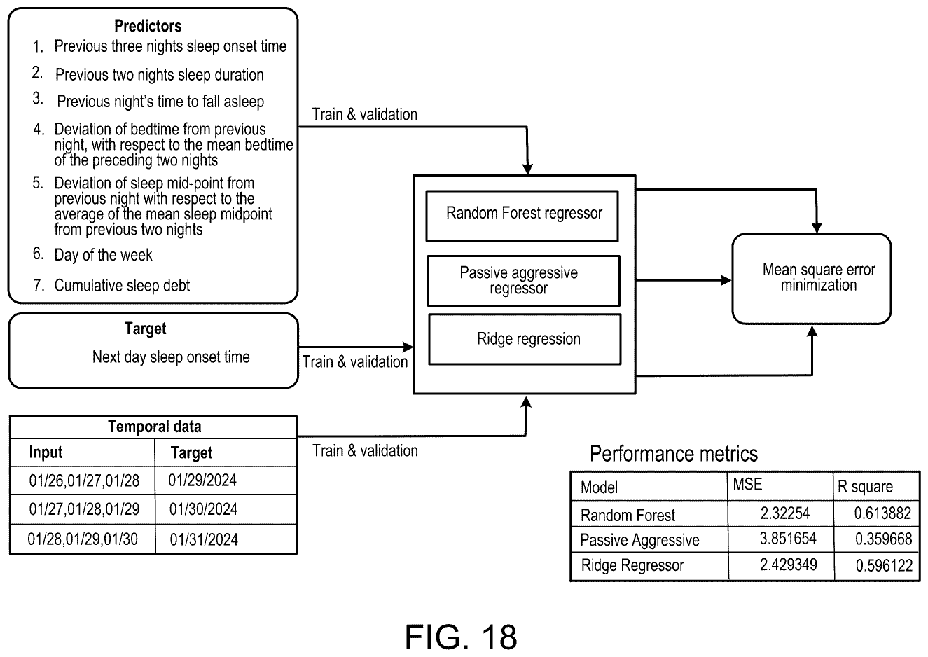

For example, and as illustrated in FIG. 18, the machine learning model may be trained using the sleep onset time for the previous three nights, the sleep duration time for the previous two nights, the deviation of bedtimes from the previous night, with respect to the mean bedtime of the preceding two nights, the deviation of sleep mid-point from previous night with respect to the average of the mean sleep midpoint from the previous two nights, the day of the week, and the cumulative sleep debt of the user. As will be appreciated, any number of nights for any of the following data points may be used. In some implementations, the machine learning model may be trained based on the determined sleep regularity factor of the user 1202 and the determined chronotype of the user 1202, that is the difference in sleep duration between the user's desired sleep schedule and the actual sleep duration of the user 1202. In some implementations, the server 1206 may use any other related sleep data to train the machine learning model. In some implementations, one or more different machine learning models may be trained by the server 1206 using the sleep data received from the control box 124. As illustrated in FIG. 18, a random forest regressor model, a passive aggressive regressor model, and a ridge regressor model may be trained to minimize the mean square error between the sleep onset time estimation and the actual value. In some implementations, the server 1206 may use a single machine learning model to predict the sleep onset time for the user 1202. In other implementations, the server 1206 use any reasonable combination of the three regression models.

With reference back to FIG. 13, the process 1300 may include the controller determining, based on an output of the machine learning model, a sleep onset time for the user (1308). For example, this may include the control box 124 determining a sleep onset time for the user 1202 using the machine learning model. The machine learning model may predict a sleep onset time for the particular user 1202 based on the user's historic sleep data.

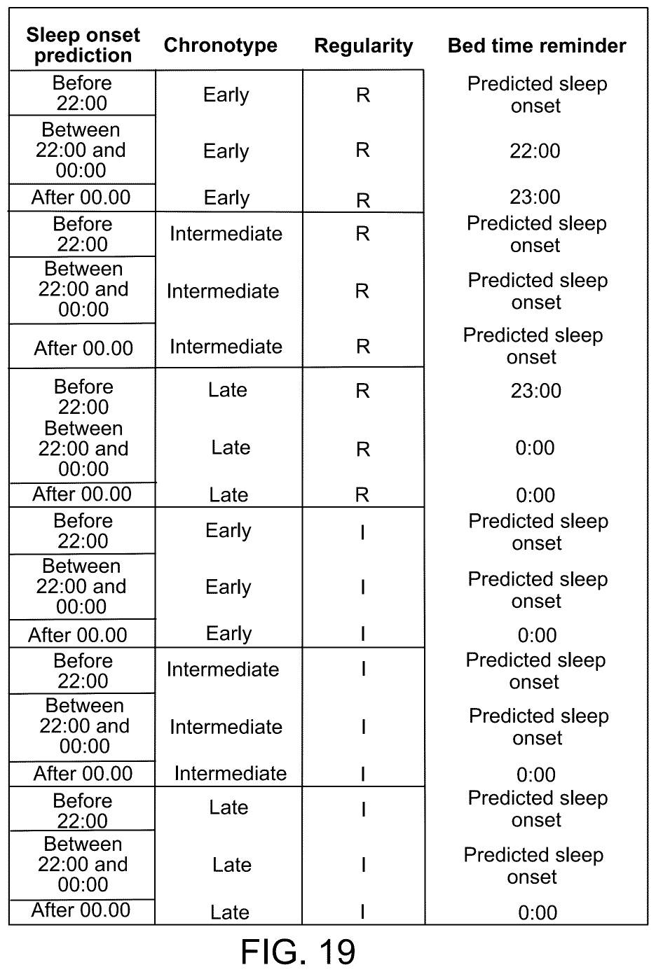

The process 1300 may include the controller determining a target time to communicate a bedtime reminder notification to the user responsive to determining a sleep onset time for the user (1310). For example, this may include the control box 124 using a machine learning model that is trained to determine a target time to communicate a bedtime reminder notification 1210 to a user 1202 based on the user chronotype and sleep regularity. In some implementations, the machine learning model may use an algorithm to determine the target time to communicate the bedtime reminder notification 1210 to the user 1202. In some implementations, the control box 124 may utilize a look-up table to determine the target time to communicate the bedtime reminder notification 1210 to the user. For example, the control box 124 may utilize a look-up take, as illustrated in FIG. 19 to determine the target time to communicate the bedtime reminder notification 1210 to the user 1206. In the example illustrated in FIG. 19, the look-up table may include eighteen rows which correspond to all of the possible combinations of sleep onset prediction time ranges, chronotype categories and sleep regularity factor categories. Other look-up tables may have other possible combinations.

The process 1300 may include and the controller communicating the bedtime reminder notification to the user, responsive to determining a target time to communicate a bedtime reminder notification to the user (1312). For example, this may include the control box 124 communicating a bedtime reminder notification 1210 to a user device 1204 of the user 1202. In some implementations, the server 1206 that is in communication with the control box 124 may communicate the bedtime reminder notification 1210 to the user device 1204 of the user 1202. For example, the bedtime reminder notification 1210 may be communicated as a push notification through a sleep analytics application on the user device 1204. In some implementations, the control box 124 may communicate to a sensor associated with the bed 306 to output an audible sound as a bedtime reminder to the user 1202. For example, the control box 124 may command a speaker associated with the bed 306 to output an audible sound as a bedtime reminder to the user 1202. In some implementations, the control box 124 may communicate to a light sensor associated with the bed 306 to output a visible light as a bedtime reminder to the user 1202. For example, the control box 124 may command a light associated with the bed 306 to flash red as a bedtime reminder to the user 1202. In some implementations, the user 1202 may set a preference for how the bedtime reminder should be communicated to the user 1202. In these implementations, the user 1202 may launch the sleep analytics application on their user device 1204 to set their bedtime reminder preferences.

In some implementations, the control box 124 may provide one or more other types of notifications and or automations. For example, the control box 124 may communicate with a speaker to output soft music thirty minutes before the user desired sleep onset time to prefer the user 1202 for sleep. In another example, the control box 124 may communicate with a thermocouple resistor that controls the temperature of the bed 306, to decrease the temperature of the mattress of the bed 306. In other examples, where the user preference indicates that the user 1202 prefers the bed 306 to be warmer at bedtime, the control box 124 may communicate with the thermocouple resister to increase the temperature of the mattress of the bed 306. In yet another example, the control box 124 may communicate with one or more lights in the room with the bed 306, to command the one or more lights to be dimmed in the time period leading up to the user's sleep onset time. In another example, the control box 124 may be configured to communicate a reminder to the user 1202 an hour before the sleep onset time, the reminder may be used to indicate to the user to prepare for bed 306.

FIG. 14 is a flow chart illustrating process 1400 for communicating a bedtime reminder notification to the user. Briefly, the process 1400 may include may include a server that includes a processor and a computer-readable memory, and that is in communication with a controller, receiving data that is representative of historic sleep times and historic wake times for a user of the bed from the controller (1402), the server determining, based on the data that is representative of historic sleep times and historic wake times for the user, a sleep regularity factor for the user and a chronotype of the user (1404), the server training a machine learning model to determine a sleep onset time for the user based on the data that is representative of historic sleep time and historic wake times for the user (1406), the server using the machine learning model to determine the sleep onset time for the user (1408), the server determining a target time to communicate a bedtime reminder notification to the user responsive to determining a sleep onset time for the user (1410), the server determining that the target time to communicate the bedtime reminder notification to the user is approaching (1412), the server determining whether the user is in the bed based on determining that the target time to communicate the bedtime reminder to the user is approaching (1414), and the server communicating the bedtime reminder notification to the user based on determining that the user is not in the bed (1416).

In more detail, process 1400 may include a server that includes a processor and a computer-readable memory, and that is in communication with a controller, receiving data that is representative of historic sleep times and historic wake times for a user of the bed from the controller (1402). For example, this may include the server 1206 receiving data from the control box 124 of the bed 306. The data received from the control box 124 may be data that is collected from one or more other sensors associated with the bed 306 which indicate various biometric signals such as heart rate, respiration, and/or movement of the user. In some implementations, the control box 124 may be configured to receive pressure data from a pressure sensor that monitors the air pressure of the air chambers 306a and 306b. In these implementations, the control box 124 may be configured to monitor the fluctuation in the air pressure to determine a sleep state of the user 1202. The control box 124 may be configured to use the various sensor data to determine when the user 1202 fell sleep, that is the user sleep time, and when the user wakes up, that is the user wake time, each time the user 1202 is in the bed 306. The control box 124 may store each of the user sleep times and user wake times as historic sleep and wake times in a memory associated with the control box 124. In some implementations, the control box 124 communicates the user sleep times and user wake times to the server 1206, and the server 1206 stores the data in a memory associated with the server 1206. For example, the server 1206 may store the user sleep times and user wake time for a period of two weeks, a month, or a year. In some implementations, the server 1206 may store the user sleep times and user wake times for any period of time.

In some implementations, the control box 124 may receive temperature sensor data from one or more temperature sensors which are configured to detect the temperature of the mattress of the bed 306. The control box 124 may analyze the temperature data received from the one or more temperature sensors to determine various states of a user laying in the bed 306. In some implementations, the control box 124 may receive data from the pressure transducer 146, and may analyze the data to determine various states of the user laying in the bed 306. For example, control box 124 may receive data collected from the pressure transducer 146 to determine a heart rate or respiration rate of the user in the bed 306. The control box 124 may process the heart rate or respiration rate data to determine whether the user 1202 in the bed 306 is awake or asleep. The control box 124 may be further configured to determine when the user 1202 falls asleep and when the user 1202 awakes. In these implementations, the control box 124 may store the times when a user 1202 falls asleep, and when the user 1202 wakes up over a period of time. In some implementations, the control box 124 communicates the sensor data to the server 1206, and the server 1206 determines the user sleep times and the user wake times based on analyzing the sensor data.

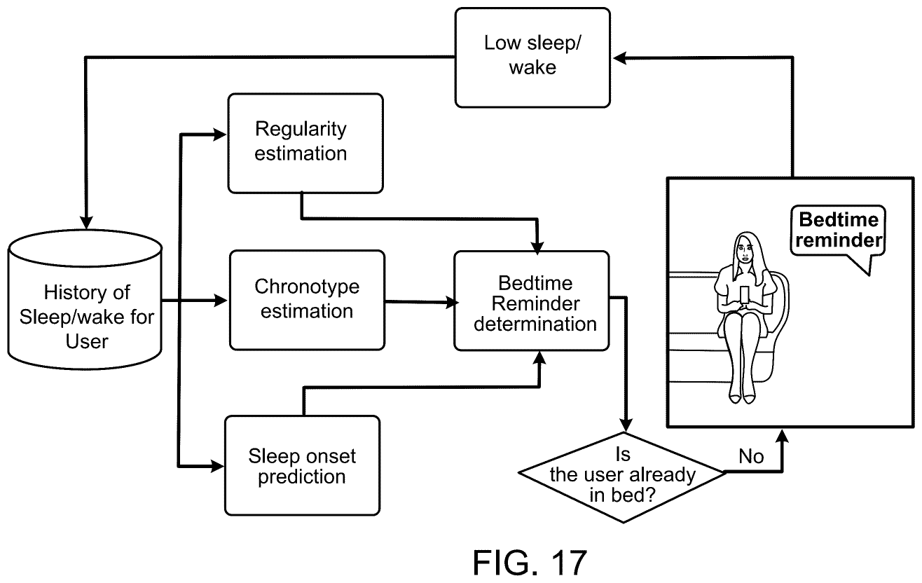

The process 1400 may include the server determining, based on the data that is representative of historic sleep times and historic wake times for the user, a sleep regularity factor for the user and a chronotype of the user (1404). For example, this may include the server 1206 determining a sleep regularity factor for the user 1202. The server 1206 may calculate a sleep regularity factor to represent the consistency of a user's sleep timing. As depicted in FIG. 17, the sleep regularity factor can be determined from the historical sleep and wake data associated with the user 1202. In some implementations, the server 1206 may quantify a user's sleep regularity factor using historic sleep data associated with the user 1202. For example, the user's sleep data from a period of time may be analyzed by dividing each day from the period of time into 96 fifteen-minute segments. As will be appreciated, the segments may be of any length and more or less than 96 segments may be used. Each of the segments may be labelled as a sleep segment or a wake segment based on whether the user 1202 is detected as being asleep during the segment of the day. The server 1206 then quantifies the regularity as a percentage of matching segments across all the days within the period of time. The calculated percentage may be converted into time-regularity to define two categories, regular with time-regularity that is less than 30 minutes, and irregular with time-regularity that is greater than 90 minutes. Any suitable time period may be used to define the two categories.

The server 1206 may determine chronotype estimation for the user 1202. As depicted in FIG. 17, the chronotype can be determined from the historical sleep and wake data associated with the user 1202. In some implementations, the server 1206 may use the received historic sleep and wake time data to determine an approximate chronotype of the user 1202. For example, the server 1206 may characterize a user 1202 as a morning/early chronotype when the 67^{th} percentile in time of sleep onset times of the user 1202 occurs before 10:00 pm. The server 1206 may characterize a user 1202 as an evening/late chronotype when the 67th percentile in time of sleep onset times of the user 1202 occurs after 12:00 am or later. The server 1206 may characterize a user 1202 as an intermediate chronotype when 67^{th} percentile in time of the user's sleep onset times occur between 10:00 pm and 11:59 pm.

The process 1400 may include the server training a machine learning model to determine a sleep onset time for the user based on the data that is representative of historic sleep time and historic wake times for the user (1406). For example, this may include the server 1206 training a machine learning model via a supervised learning process using a large corpus of sleep data. As illustrated in FIG. 18, the machine learning model may be trained using the sleep onset time for the previous three nights, the sleep duration time for the previous two nights, the deviation of bedtimes from the previous night, with respect to the mean bedtime of the preceding two nights, the deviation of sleep mid-point from previous night with respect to the average of the mean sleep midpoint from the previous two nights, the day of the week, and the cumulative sleep debt of the user 1202. As will be appreciated, any number of nights for any of the following data points may be used.

In some implementations, the machine learning model may be trained based on the determined sleep regularity factor of the user 1202 and the determined chronotype of the user 1202, that is the difference in sleep duration between the personal goal and the actual sleep duration of the user 1202. In some implementations, the server 1206 may use any other related sleep data to train the machine learning model. In some implementations, one or more different machine learning models may be trained by the server 1206 using the sleep data received from the control box 124. As illustrated in FIG. 18, a random forest regressor model, a passive aggressive regressor model, and a ridge regressor model may be trained to minimize the mean square error between the sleep onset time estimation and the actual value. In some implementations, the server 1206 may use a single machine learning model to predict the sleep onset time for user 1202. In other implementations, the server 1206 may use any combination of the three regression models.

The process 1400 may include the server using the machine learning model to determine the sleep onset time for the user (1408). For example, this may include the server 1206 determining a sleep onset time for the user 1202 using the machine learning model. The machine learning model may predict a sleep onset time for the particular user 1202 based on the user's historic sleep data.

The process 1400 may include the server determining a target time to communicate a bedtime reminder notification to the user responsive to determining a sleep onset time for the user (1410). For example, this may include the server 1206 using a machine learning model that is trained to determine a target time to communicate a notification 1210 to a user 1202 based on the user chronotype and sleep regularity. In some implementations, the machine learning model may use an algorithm to determine the target time to communicate the notification 1210 to the user 1202. In some implementations, the server 1206 may utilize a look-up table to determine the target time to communicate the bedtime reminder notification 1210 to the user 1202. For example, the server 1206 may utilize a look-up table, as illustrated in FIG. 19 to determine the target time to communicate the bedtime reminder notification 1210 to the user 1202. As illustrated in FIG. 19, the look-up table may include eighteen rows which correspond to all of the possible combinations of sleep onset prediction time ranges, chronotype categories and sleep regularity factor categories. Other look-up tables may have other possible combinations.

The process 1400 may include the server determining that the target time to communicate the bedtime reminder notification to the user is approaching (1412). For example, this may include the server 1206 comparing the current time to the determined target time to communicate the bedtime reminder notification 1210. In some implementations, the server 1206 may determine that the target time is approaching when the current time is within ten minutes or five minutes of the target time to communicate the bedtime reminder notification 1210. In some implementations, the server 1206 may determine that the target time is approaching when the current time is within an appropriate time period from the target time to communicate the bedtime reminder notification.

The process 1400 may include the server determining whether the user is in the bed based on determining that the target time to communicate the bedtime reminder to the user is approaching (1414). For example, this may include the server 1206 receiving sensor data that is collected by the control box 124, and using the sensor data to determine whether the user 1202 is in the bed 306. In some implementations, the control box 124 may receive temperature sensor data from the one or more temperature sensors on the mattress of the bed 306. The control box 124 may communicate the temperature sensor data to the server 1206. The server 1206 may analyze the received temperature sensor data to determine whether the sensor data indicates that a user 1202 is in the bed 306.

In some implementations, the server 1206 may use a temperature-based machine learning model which is trained to determine user presence based on received temperature data, to determine user presence in the bed 306. In some implementations, the server 1206 may analyze the received temperature data to determine user presence in the bed 306 based on comparing the received temperature readings to a temperature detecting threshold. For example, the server 1206 may determine user presence in the bed 306 when at least one temperature sensor detects a temperature that exceeds the temperature detecting threshold. In some implementations, the server 1206 may analyze the temperature data to determine user presence in the bed 306 based on determining a rate of temperature change. For example, the server 1206 may receive temperature data that is collected at a first time, a first temperature reading from a temperature sensor, and may receive, at a second time, a second temperature data from the temperature sensor. The server 1206 may determine the rate of change of temperature by dividing the difference in temperature by the difference in time between the first and second times. The server 1206 may determine the user is present in the bed 306 when the rate of change of temperature exceeds a rate threshold.

In some implementations, the server 1206 may use a pressure-based machine learning model which is trained to determine user presence based on received pressure data, to determine user presence in the bed 306. For example, the server 1206 may analyze the air chamber pressure signals for the air chambers of the bed 306 that are received by the control box 124. When a user 1202 enters the bed 306, the change in the pressure signals received by the control box 124 is instant. Based on the instant increase in the pressure readings, the server 1206 may determine that the user 1202 is present in the bed 306.

The process 1400 may include the server communicating the bedtime reminder notification to the user based on determining that the user is not in the bed, (1416). For example, this may include the server 1206 communicating a bedtime reminder notification 1210 to a user device 1204 of the user 1202. For example, the bedtime reminder notification 1210 may be communicated as a push notification through a sleep analytics application on the user device 1204. In some implementations, the server 1206 may communicate to a sensor associated with the bed 306 to output an audible sound as a bedtime reminder to the user 1202. For example, the server 1206 may command a speaker associated with the bed 306 to output an audible sound as a bedtime reminder to the user 1202.

In some implementations, the server 1206 may communicate to a light sensor associated with the bed 306 to output a visible light as a bedtime reminder to the user 1202. For example, the server 1206 may command a light associated with the bed 306 to flash red as a bedtime reminder to the user 1202. In some implementations, the user 1202 may set a preference for how the bedtime reminder should be communicated to the user 1202. In these implementations, the user 1202 may launch the sleep analytics application on their user device 1204 to set their bedtime reminder preferences.

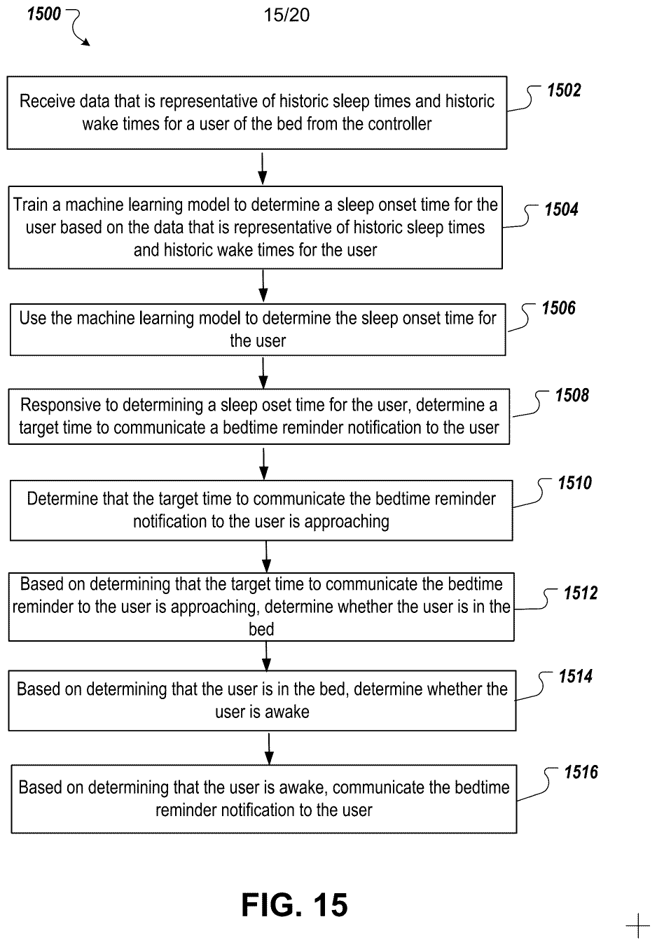

FIG. 15 is a flow chart illustrating a process 1500 for communicating a bedtime reminder notification to a user. Briefly, the process 1500 may include a server that includes a processor and a computer-readable memory, and that is in communication with a controller, receiving data that is representative of historic sleep times and historic wake times for a user of the bed from the controller (1502), the server training a machine learning model to determine a sleep onset time for the user based on the data that is representative of historic sleep times and historic wake times for the user (1504), the server using the machine learning model to determine the sleep onset time for the user (1506), the server determining a target time to communicate a bedtime reminder notification to the user responsive to determining a sleep onset time for the user (1508), the server determining that the target time to communicate the bedtime reminder notification to the user is approaching (1510), the server determining whether the user is in the bed based on determining that the target time to communicate the bedtime reminder to the user is approaching (1512), the server determining whether the user is awake based on determining that the user is in the bed (1514), and the server communicating the bedtime reminder notification to the user based on determining that the user is awake (1516).

In more detail, process 1500 may include a server that includes a processor and a computer-readable memory, and that is in communication with a controller, receiving data that is representative of historic sleep times and historic wake times for a user of the bed from the controller (1502). For example, this may include the server 1206 receiving data from the control box 124 of the bed 306. The data received from the control box 124 may be data that is collected from one or more other sensors associated with the bed 306 which indicate various biometric signals such as heart rate, respiration, and/or movement of the user. In some implementations, the control box 124 may be configured to receive pressure data from a pressure sensor that monitors the air pressure of the air chambers 306a and 306b. In these implementations, the control box 124 may be configured to monitor the fluctuation in the air pressure to determine a sleep state of the user 1202. The control box 124 may be configured to use the various sensor data to determine when the user fell sleep, that is the user sleep time, and when the user wakes up, that is the user wake time, each time the user is in the bed 306. The control box 124 may store each of the user sleep times and user wake times as historic sleep and wake times in a memory associated with the control box 124. In some implementations, the control box 124 communicates the user sleep times and user wake times to the server 1206, and the server 1206 stores the data. For example, the server 1206 may store the user sleep times and user wake time for a period of two weeks, a month, or a year. In some implementations, the server 1206 may store the user sleep times and user wake times for any period of time.

In some implementations, the control box 124 may receive temperature sensor data from one or more temperature sensors which are configured to detect the temperature of the mattress of the bed 306. The control box 124 may analyze the temperature data received from the one or more temperature sensors to determine various states of a user laying in the bed 306. In some implementations, the control box 124 may receive data from the pressure transducer 146, and may analyze the data to determine various states of the user laying in the bed 306. For example, control box 124 may receive data collected from the pressure transducer 146 to determine a heart rate or respiration rate of the user in the bed 306. The control box 124 may process the heart rate or respiration rate data to determine whether the user 1202 in the bed 306 is awake or asleep. The control box 124 may be further configured to determine when a user 1202 falls asleep and when the user awakes. In these implementations, the control box may store the times when a user falls asleep, and when the user wakes up over a period of time. In some implementations, the control box 124 communicates the sensor data to the server 1206, and the server 1206 determines the user sleep times and the user wake times based on analyzing the sensor data.

The process 1500 may include the server training a machine learning model to determine a sleep onset time for the user based on the data that is representative of historic sleep times and historic wake times for the user (1504). For example, this may include the server 1206 training a machine learning model via a supervised learning process using a large corpus of sleep data. For example, the machine learning model may be trained using historic sleep data associated with the user 1202.

The process 1500 may include the server using the machine learning model to determine the sleep onset time for the user (1506). For example, this may include the server 1206 determining a sleep onset time for the user 1202 using the machine learning model. The machine learning model may predict a sleep onset time for the particular user 1202 based on the user's historic sleep data.

The process 1500 may include the server determining a target time to communicate a bedtime reminder notification to the user responsive to determining a sleep onset time for the user (1508). For example, this may include the server 1206 using a machine learning model that is trained to determine a target time to communicate a notification to a user based on the user chronotype and sleep regularity. In some implementations, the machine learning model may use an algorithm to determine the target time to communicate the notification 1210 to the user 1202. In some implementations, the server 1206 may utilize a look-up table to determine the target time to communicate the bedtime reminder notification 1210 to the user 1202. For example, the server 1206 may utilize a look-up table, as illustrated in FIG. 19 to determine the target time to communicate the bedtime reminder notification 1210 to the user 1202. As illustrated in FIG. 19, the look-up table may include eighteen rows which correspond to all of the possible combinations of sleep onset prediction time ranges, chronotype categories and sleep regularity factor categories. Other look-up tables may have other possible combinations.

The process 1500 may include the server determining that the target time to communicate the bedtime reminder notification to the user is approaching (1510). For example, this may include the server 1206 comparing the current time to the determined target time to communicate the bedtime reminder notification. In some implementations, the server 1206 may determine that the target time is approaching when the current time is within ten minutes or five minutes of the target time to communicate the bedtime reminder. In some implementations, the server 1206 may determine that the target time is approaching when the current time is within an appropriate time period from the target time to communicate the bedtime reminder.

The process 1500 may include the server determining whether the user is in the bed based on determining that the target time to communicate the bedtime reminder to the user is approaching (1512). For example, this may include the server 1206 receiving sensor data that is collected by the control box 124, and using the sensor data to determine whether the user 1202 is in the bed 306. In some implementations, the control box 124 may receive temperature sensor data from the one or more temperature sensors on the mattress of the bed 306. The control box 124 may communicate the temperature sensor data to the server 1206. The server 1206 may analyze the received temperature sensor data to determine whether the sensor data indicates that a user 1202 is in the bed 306.

In some implementations, the server 1206 may use a temperature-based machine learning model which is trained to determine user presence based on received temperature data, to determine user presence in the bed 306. In some implementations, the server 1206 may analyze the received temperature data to determine user presence in the bed 306 based on comparing the received temperature readings to a temperature detecting threshold. For example, the server 1206 may determine user presence in the bed 306 when at least one temperature sensor detects a temperature that exceeds the temperature detecting threshold. In some implementations, the server 1206 may analyze the temperature data to determine user presence in the bed 306 based on determining a rate of temperature change. For example, the server 1206 may receive temperature data that is collected at a first time, a first temperature reading from a temperature sensor, and may receive, at a second time, a second temperature data from the temperature sensor. The server 1206 may determine the rate of change of temperature by dividing the difference in temperature by the difference in time between the first and second times. The server 1206 may determine the user 1202 is present in the bed 306 when the rate of change of temperature exceeds a rate threshold.

In some implementations, the server 1206 may use a pressure-based machine learning model which is trained to determine user presence based on received pressure data, to determine user presence in the bed 306. For example, the server 1206 may analyze the air chamber pressure signals for the air chambers of the bed 306 that are received by the control box 124. When a user 1202 enters the bed 306, the change in the pressure signals received by the control box 124 is instant. Based on the instant increase in the pressure readings, the server 1206 may determine that the user 1202 is present in the bed 306.

The process 1500 may include the server determining whether the user is awake based on determining that the user is in the bed (1514). For example, this may include the server 1206 receiving sensor data from the control box 124, and analyzing the sensor data to determine whether the user 1202 is awake. In some implementations, data collected by the pressure transducer 146 may be analyzed by the server 1206 to determine various states of a user laying in the bed 306. For example, the server 1206 may receive data collected by the control box 124 from the pressure transducer 146, the server 1206 may analyze the data to determine a heart rate or respiration rate of the user in the bed 306. The server 1206 may process the heart rate, movement level, or respiration rate data to determine whether the user 1202 in the bed 306 is awake or asleep.

The process 1500 may include the server communicating the bedtime reminder notification to the user based on determining that the user is awake (1516). For example, this may include the server 1206 communicating a bedtime reminder notification 1210 to a user device 1204 of the user 1202. For example, the bedtime reminder notification 1210 may be communicated as a push notification through a sleep analytics application on the user device 1204. In some implementations, the server 1206 may communicate to a sensor associated with the bed 306 to output an audible sound as a bedtime reminder to the user 1202. For example, the server 1206 may command a speaker associated with the bed 306 to output an audible sound as a bedtime reminder to the user 1202. In some implementations, the server 1206 may communicate to a light sensor associated with the bed 306 to output a visible light as a bedtime reminder to the user 1202. For example, the server 1206 may command a light associated with the bed 306 to flash red as a bedtime reminder to the user 1202. In some implementations, the user 1202 may set a preference for how the bedtime reminder should be communicated to the user 1202. In these implementations, the user 1202 may launch the sleep analytics application on their user device 1204 to set their bedtime reminder preferences.

In some implementations, the system may include one or more sensors for a bed 306, and a control box 124 connected to the one or more sensors for the bed 306. The control box 124 may be configured to receive data that is representative of historic sleep times and historic wake times for a user 1202 of the bed 306. The control box 124 may be configured to train a machine learning model to determine a sleep onset time for the user 1202 based on the data that is representative of historic sleep times and historic wake times for the user 1202. As described above with respect to FIG. 15, the control box 124 may be configured to train a machine learning model to determine a sleep onset time for the user 1202 and use the machine learning model to determine the sleep onset time for the user 1202.

In some implementations, when the control box 124 determines that the user is awake, the control box 124 may communicate a signal to one or more components of the bed 306 to adjust a parameter of the bed 306 to a sleep preference. For example, the control box 124 may communicate with a temperature regulator associated with the bed 306 to adjust a temperature of the bed 306. The temperature regulator may be configured to increase the temperature or decrease the temperature of the bed 306. In some implementations, the user 1202 may access the sleep analytics application on the user device 1204 to set sleep preferences which may include the temperature of the bed 306, the ambient temperature of the room with the bed 306, the articulation or posture of the user 1202, the firmness of the mattress of the bed 306, or any other suitable adjustable parameter associated with the bed 306. When the control box 124 determines that the sleep onset time is approaching and the user 1202 is in the bed 306 and is still awake, the control box 124 may be configured to adjust each of the one or more parameters to the user preference to help encourage the user 1202 to fall asleep.

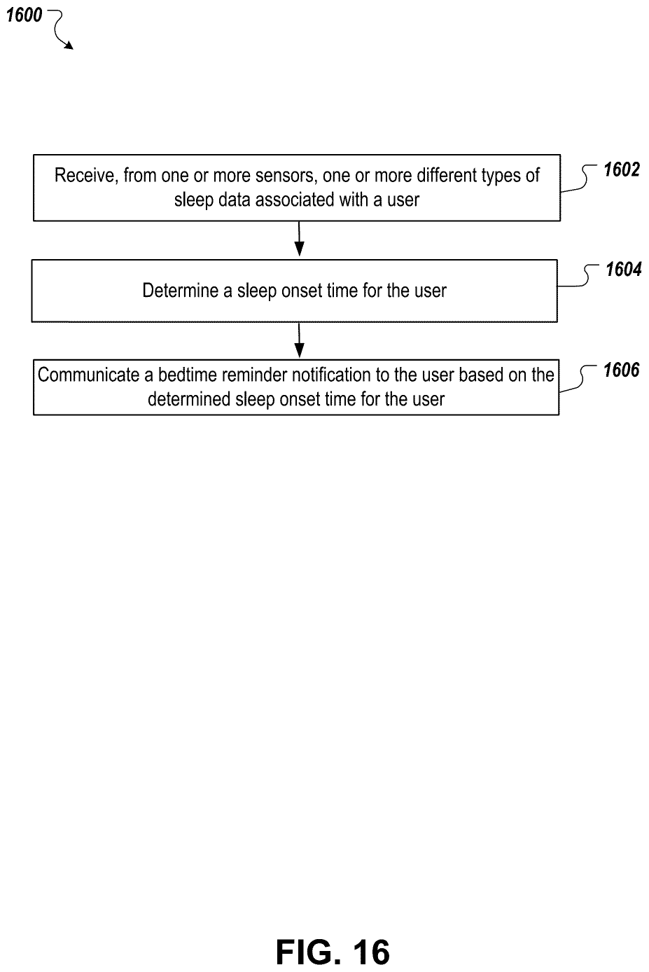

FIG. 16 is a flow chart illustrating a process 1600 for communicating a bedtime reminder notification to the user based on the determined sleep onset time for the user. Briefly, the process 1600 may include a controller that includes a processor and a computer-readable memory, receiving from one or more sensors, one or more different types of sleep data associated with a user (1602), the controller determining a sleep onset time for the user (1604), and the controller communicating a bedtime reminder notification to the user based on the determined sleep onset time for the user (1606).

In more detail, the process 1600 may include the controller receiving from one or more sensors, one or more different types of sleep data associated with a user (1602). For example, this may include the control box 124 receiving data from one or more temperature sensors on the mattress of the bed 306. In some implementations, the bed 306 may be equipped with one or more temperature sensors which are configured to detect the temperature of the mattress of the bed 306. The control box 124 may receive data collected from the pressure transducer 146 to determine a heart rate or respiration rate of the user 1202 in the bed 306. The control box 124 may receive data from one or more other sensors associated with the bed 306 which indicate various biometric signals such as heart rate, respiration, and/or movement of the user 1202. For example, the bed 306 may be equipped with one or more heart rate and breathing sensors, and the control box 124 may receive data from the heart rate and breathing sensors.

The control box 124 may be configured to receive pressure data from a pressure sensor that monitors the air pressure of the air chambers 306a and 306b. In these implementations, the control box 124 may be configured to monitor the fluctuations in the air pressure to determine a sleep state of the user 1202. In some implementations, the bed 306 may be equipped with one or more pressure sensors which are configured to measure the pressure exerted on different areas of the user's body when the user 1202 is sleeping in the bed 306. In these implementations, the control box 124 may receive pressure data received from the one or more pressure sensors. In some implementations, the bed 306 may be equipped with one or more motion sensors. The one or more motion sensors may be configured to detect the changes in a user's body position and movement of the user while the user 1210 is in the bed 306.

In some implementations, the processing of the sensor data is performed by a server 1206 that is in communication with the control box 124. The server 1206 may be a backend server that supports the functionality of a sleep application. In these implementations, the control box 124 may communicate the received sensor data to the server for the server 1206 to analyze the sensor data. In some implementations, the control box 124 may communicate the sensor data to the server 1206 when the sensor data is received. In other implementations, the control bx 124 may periodically communicate the sensor data to the server 1206. For example, the control box 124 may communicate the received sensor data to the server every sixty seconds, or every hour, or every 24 hours, or any other suitable period.

The process 1600 may include the controller determining a sleep onset time for the user (1604). For example, this may include the control box 124 analyzing the sleep data received from the one or more sensors to determine the time the user falls asleep, that is the user sleep onset time. The control box 124 may analyze the temperature data collected from the one or more temperature sensors to determine various states of a user laying in the bed 306. For example, the temperature data may be analyzed to determine when a user is present in the bed 306. The control box 124 may analyze the pressure data collected by the pressure transducer to determine various states of a user laying in the bed 306. The control box 124 may process the received heart rate or respiration rate data to determine whether the user 1202 in the bed 306 is awake or asleep. The control box 124 may further analyze the received sensor data to determine the time when a user 1202 falls asleep and the time when the user 1202 awakes.

The control box 124 may be configured to store the times for when a user 1202 falls asleep, and the times for when the user 1202 wakes up each day for a period of days. The control box 124 may be configured to store each of the user sleep times and user wake times as historic sleep and wake times in a memory associated with the control box 124. For example, the control box 124 may store the user sleep times and user wake time for a period of two weeks, a month, or a year. In some implementations, the control box 124 may store the user sleep times and user wake times for any period of time.

In some implementations, the control box 124 determines the sleep onset time for the user 1202 by utilizing a biomathematical model. For example, the biomathematical model may be a deterministic model. In other examples, the biomathematical model used by the control box 124 may be a continuous model, a discrete model, a stochastic model, or any appropriate combination of models.

In the implementations where the server 1206 processes the sensor data, the server 1206 is configured to analyze the received sensor data to determine the time when the user falls asleep, that is the user sleep onset time. The server 1206 may analyze the temperature data collected from the one or more temperature sensors to determine various states of a user laying in the bed 306. The server may process and analyze the received heart rate and respiration data to determine whether the user 1206 in the bed 306 is awake of asleep. The server 1206 may further analyze the received sensor data to determine the time when a user falls asleep and the time when the user awakes. In some implementations, the server 1206 may be configured to store the times for when a user falls asleep and the times for when the user wakes up each day for a period of days. The server 1206 may be configured to store each of the user sleep times and user wake times as historic sleep and wake times in a memory associated with the server 1206. For example, the server 1206 may store the user sleep times and user wake time for a period of two weeks, a month, or a year. In some implementations, the server 1206 may store the user sleep times and user wake times for any period of time.

The process 1600 may include the controller communicating a bedtime reminder notification to the user based on the determined sleep onset time for the user (1606). For example, this may include the control box 124 utilizing a machine model that is trained to determine a sleep onset time for the user 1202 to determine a sleep onset time for the user 1202, and the control box 124 communicating the bedtime reminder notification as a push notification to a user device 1204 of the user 1202. In more detail, the control box 124 may be configured to train a machine learning model to determine a sleep onset time for a user 1202. The control box 124 may train the machine learning model is a supervised learning process using a large corpus of sleep data. As illustrated in FIG. 19, the machine learning model may be trained using the sleep onset time for the previous three nights, the sleep duration time for the previous two nights, the deviation of bedtimes from the previous night, with respect to the mean bedtime of the preceding two nights, the deviation of sleep mid-point from previous night with respect to the average of the mean sleep midpoint from the previous two nights, the day of the week, and the cumulative sleep debt of the user. As will be appreciated, any number of nights for any of the following data points may be used.

In some implementations, the control box 124 may train the machine learning model based on a determine sleep regularity factor and the determine chronotype of the user 1202. The control box 124 may calculate a sleep regularity factor to represent the consistency of a user's sleep timing. In some implementations, the control box 124 may quantify a user's sleep regularity factor using historic sleep data associated with the user 1202. For example, the user's sleep data from a period of time may be analyzed by dividing each day from the period of time into 96 fifteen-minute segments. As will be appreciated, the segments may be of any length and more or less than 96 segments may be used. Each of the segments may be labelled as a sleep segment or a wake segment based on whether the user is detected as being asleep during the segment of the day. The control box 124 may then quantifies the regularity as a percentage of matching segments across all the days within the period of time. The calculated percentage may be converted into time-regularity to define two categories, regular with time-regularity that is less than 30 minutes, and irregular with time-regularity that is greater than 90 minutes.

The control box 124 may determine chronotype estimation for the user 1202. A chronotype is user's subjective preference for being active or sleeping at certain times of the day. A user's chronotype can be classified as a morning/early chronotype, an evening/late chronotype, or an intermediate chronotype. In some implementations, the control box 124 may use the received historic sleep and wake time data to determine an approximate chronotype of the user 1202. For example, the control box 124 may characterize a user as a morning/early chronotype when the 67^{th} percentile in time of sleep onset times of the user occurs before 10:00 pm. The control box 124 may characterize a user as an evening/late chronotype when the 67th percentile in time of sleep onset times of the user occurs after 12:00 am or later. The control box 124 may characterize a user as an intermediate chronotype when 67^{th} percentile in time of the user's sleep onset times occur between 10:00 pm and 11:59 pm.

In some implementations, one or more different machine learning models may be trained by the server 1206 using the sleep data received from the control box 124. As illustrated in FIG. 19, a random forest regressor model, a passive aggressive regressor model, and a ridge regressor model may be trained to minimize the mean square error between the sleep onset time estimation and the actual value. In some implementations, the server 1206 may use a single machine learning model to predict the user sleep onset time. In other implementations, the server 1206 may use any combination of the three regression models.

The control box 124 may communicate a bedtime reminder notification 1210 to the user 1202 based on the determined sleep onset time for the user 1202. In some implementations, the control box 124 may communicate the bedtime reminder notification 1210 to a user device 1204 of the user 1202. For example, the control box 124 may communicate the bedtime reminder notification as a push notification through a sleep analytics application on the user device 1204 of the user. In some implementations, the control box 124 may communicate the bedtime reminder notification 1210 to the user 1202 at the determined sleep onset time for the user 1202. In other implementations, the control box 124 may communicate the bedtime reminder notification to the user 1202 at a time period before the determined sleep onset time for the user 1202. For example, the control box 124 may communicate the bedtime reminder notification 1210 to the user 1202 ten minutes before the determined sleep onset time for the user 1202. The control box 124 may communicate the bedtime reminder notification five minutes, thirty minutes, one minute, or any other suitable time period before the determined sleep onset time.

In some implementations, the control box 124 may utilize a machine learning module that is trained to determine the best time to communicate the bedtime notification to the user 1202 to determine when to communicate the notification to the user 1202. In these implementations, control box 124 may utilize a machine learning module that is trained based on the user chronotype and user sleep regularity. In other implementations, the control box 124 may utilize a look-up table to determine the best time to communicate the bedtime reminder notification to the user 1202. For example, the control box 124 may utilize a look-up table, as illustrated in FIG. 19 to determine the best time to communicate the bedtime reminder notification to the user 1202. As illustrated in FIG. 19, the look-up table may include eighteen rows which correspond to all of the possible combinations of sleep onset prediction time ranges, chronotype categories and sleep regularity factor categories. Other look-up tables may have other possible combinations.

In some implementations, the control box 124 may determine whether the user 1202 is in the bed 306 before communicating the bedtime reminder notification 1210 to the user 1202. As described above with respect to FIG. 14, the control box 124 may receive sensor data from the one or more sensors of the bed 306, and analyze the sensor data to determine whether the user 1202 is in the bed 306. In some implementations, when the control box 124 determines that the user 1202 is not in the bed 306, the control box 124 communicates the bedtime notification reminder to the user 1202. In some implementations, when the control box 124 determines that the user 1202 is in the bed 306, the control box 124 may not communicate the bedtime reminder to the user 1202. In other implementations, when the control box 124 determines that the user 1202 is in the bed, the control box 124 may analyze additional sensor data to determine whether the user 1202 is awake or asleep before communicating the bedtime reminder notification 1210 to the user 1202.

In the implementations where the server 1206 processes the sensor data, the server 1206 is configured to communicate the bedtime reminder notification to the user 1202. For example, the server 1206 may utilize a machine learning model that is trained to determine a sleep onset time for the user to determine a sleep onset time for the user 1202, and the server 1206 may communicate the bedtime reminder notification 1210 to a user device 1204 of the user 1202. In these implementations, the server 1206 may be configured to train a machine learning model as described above with respect to FIG. 14.

FIG. 17 is an example workflow for determining to send a bedtime reminder. As illustrated in FIG. 17, the control box 124 and/or the server 1206 may store in memory the historic sleep data associated with the user 1202. The historic sleep data may include the sleep data such as the user sleep times and the user wake times for the past period of days. As described with respect to FIGS. 14-16, the control box 124 and/or the serve 1206 may use the historic sleep data associated with the user 1202 to determine a sleep regularity factor for the user 1202, a chronotype estimation for the user 1202, and determines a sleep onset time for the user 1202. The control box 124 and/or the server 1206 may use the determined sleep regularity factor or the user 1202, the determined chronotype estimation for the user 1202, and the determined a sleep onset time for the user 1202 to determine when to communicate a bedtime reminder notification to the user 1202. In some implementations, as described above, the control box 124 and/or the server 1206 may determine whether the user 1202 is in bed 306 to determine whether or not to communicate the bedtime reminder to the user 1202. In some implementations, as described above, the control box 124 and/or the server 1206 may determine whether the user 1202 is in bed 306 to determine when to communicate the bedtime reminder to the user 1202.

FIG. 18 is an example workflow for using training one or more machine learning models. As depicted in FIG. 18, the machine learning model may be trained using the sleep onset time for the previous three nights, the sleep duration time for the previous two nights, the deviation of bedtimes from the previous night, with respect to the mean bedtime of the preceding two nights, the deviation of sleep mid-point from previous night with respect to the average of the mean sleep midpoint from the previous two nights, the day of the week, and the cumulative sleep debt of the user 1202. As will be appreciated, any number of nights for any of the following data points may be used.

In some implementations, the machine learning model may be trained based on the determined sleep regularity factor of the user 1202 and the determined chronotype of the user 1202, that is the difference in sleep duration between the personal goal and the actual sleep duration of the user 1202. As illustrated in FIG. 18, a random forest regressor model, a passive aggressive regressor model, and a ridge regressor model may be trained to minimize the mean square error between the sleep onset time estimation and the actual value. In some implementations, the server 1206 may use a single machine learning model to predict the sleep onset time for the user 1202. In other implementations, the server 1206 use any reasonable combination of the three regression models.

FIG. 19 is a look-up table which may be used by the control box 124 and/or the server 1206 to determine the target time to communicate a bedtime reminder notification to the user 1202. The look-up table may include eighteen rows which correspond to all of the possible combinations of sleep onset prediction time ranges, chronotype categories and sleep regularity factor categories. Other look-up tables may have other possible combinations.

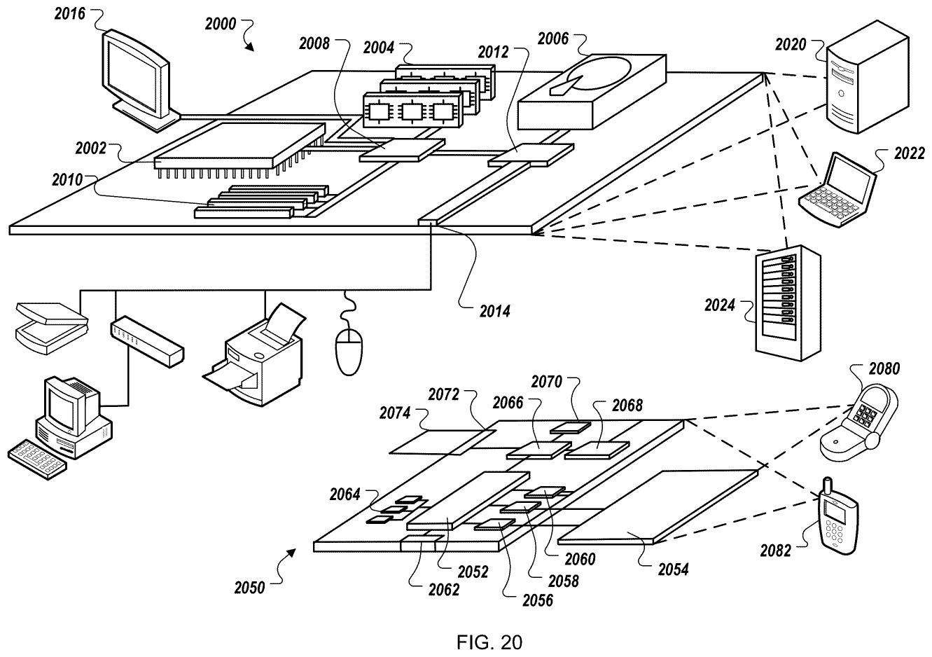

FIG. 20 shows an example of a computing device 2000 and an example of a mobile computing device that can be used to implement the techniques described here. The computing device 2000 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 2000 includes a processor 2002, a memory 2004, a storage device 2006, a high-speed interface 2008 connecting to the memory 2004 and multiple high-speed expansion ports 2010, and a low-speed interface 2012 connecting to a low-speed expansion port 2014 and the storage device 2006. Each of the processor 2002, the memory 2004, the storage device 2006, the high-speed interface 2008, the high-speed expansion ports 2010, and the low-speed interface 2012, are interconnected using various busses, and can be mounted on a common motherboard or in other manners as appropriate. The processor 2002 can process instructions for execution within the computing device 2000, including instructions stored in the memory 2004 or on the storage device 2006 to display graphical information for a GUI on an external input/output device, such as a display 2016 coupled to the high-speed interface 2008. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 2004 stores information within the computing device 2000. In some implementations, the memory 2004 is a volatile memory unit or units. In some implementations, the memory 2004 is a non-volatile memory unit or units. The memory 2004 can also be another form of computer-readable medium, such as a magnetic or optical disk.

The storage device 2006 is capable of providing mass storage for the computing device 2000. In some implementations, the storage device 2006 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer-or machine-readable medium, such as the memory 2004, the storage device 2006, or memory on the processor 2002.

The high-speed interface 2008 manages bandwidth-intensive operations for the computing device 2000, while the low-speed interface 2012 manages lower bandwidth-intensive operations. Such allocation of functions is exemplary only. In some implementations, the high-speed interface 2008 is coupled to the memory 2004, the display 2016 (e.g., through a graphics processor or accelerator), and to the high-speed expansion ports 2010, which can accept various expansion cards (not shown). In the implementation, the low-speed interface 2012 is coupled to the storage device 2006 and the low-speed expansion port 2014. The low-speed expansion port 2014, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 2000 can be implemented in a number of different forms, as shown in the figure. For example, it can be implemented as a standard server 2020, or multiple times in a group of such servers. In addition, it can be implemented in a personal computer such as a laptop computer 2022. It can also be implemented as part of a rack server system 2024. Alternatively, components from the computing device 2000 can be combined with other components in a mobile device (not shown), such as a mobile computing device 2050. Each of such devices can contain one or more of the computing device 2000 and the mobile computing device 2050, and an entire system can be made up of multiple computing devices communicating with each other.

The mobile computing device 2050 includes a processor 2052, a memory 2064, an input/output device such as a display 2054, a communication interface 2066, and a transceiver 2068, among other components. The mobile computing device 2050 can also be provided with a storage device, such as a micro-drive or other device, to provide additional storage. Each of the processor 2052, the memory 2064, the display 2054, the communication interface 2066, and the transceiver 2068, are interconnected using various buses, and several of the components can be mounted on a common motherboard or in other manners as appropriate.

The processor 2052 can execute instructions within the mobile computing device 2050, including instructions stored in the memory 2064. The processor 2052 can be implemented as a chipset of chips that include separate and multiple analog and digital processors. The processor 2052 can provide, for example, for coordination of the other components of the mobile computing device 2050, such as control of user interfaces, applications run by the mobile computing device 2050, and wireless communication by the mobile computing device 2050.

The processor 2052 can communicate with a user through a control interface 2058 and a display interface 2056 coupled to the display 2054. The display 2054 can be, for example, a TFT (Thin-Film-Transistor Liquid Crystal Display) display or an OLED (Organic Light Emitting Diode) display, or other appropriate display technology. The display interface 2056 can comprise appropriate circuitry for driving the display 2054 to present graphical and other information to a user. The control interface 2058 can receive commands from a user and convert them for submission to the processor 2052. In addition, an external interface 2062 can provide communication with the processor 2052, so as to enable near area communication of the mobile computing device 2050 with other devices. The external interface 2062 can provide, for example, for wired communication in some implementations, or for wireless communication in other implementations, and multiple interfaces can also be used.

The memory 2064 stores information within the mobile computing device 2050. The memory 2064 can be implemented as one or more of a computer-readable medium or media, a volatile memory unit or units, or a non-volatile memory unit or units. An expansion memory 2074 can also be provided and connected to the mobile computing device 2050 through an expansion interface 2072, which can include, for example, a SIMM (Single In Line Memory Module) card interface. The expansion memory 2074 can provide extra storage space for the mobile computing device 2050, or can also store applications or other information for the mobile computing device 2050. Specifically, the expansion memory 2074 can include instructions to carry out or supplement the processes described above, and can include secure information also. Thus, for example, the expansion memory 2074 can be provide as a security module for the mobile computing device 2050, and can be programmed with instructions that permit secure use of the mobile computing device 2050. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer-or machine-readable medium, such as the memory 2064, the expansion memory 2074, or memory on the processor 2052. In some implementations, the computer program product can be received in a propagated signal, for example, over the transceiver 2068 or the external interface 2062.

The mobile computing device 2050 can communicate wirelessly through the communication interface 2066, which can include digital signal processing circuitry where necessary. The communication interface 2066 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 2068 using a radio-frequency. In addition, short-range communication can occur, such as using a Bluetooth, WiFi, or other such transceiver (not shown). In addition, a GPS (Global Positioning System) receiver module 2070 can provide additional navigation-and location-related wireless data to the mobile computing device 2050, which can be used as appropriate by applications running on the mobile computing device 2050.

The mobile computing device 2050 can also communicate audibly using an audio codec 2060, which can receive spoken information from a user and convert it to usable digital information. The audio codec 2060 can likewise generate audible sound for a user, such as through a speaker, e.g., in a handset of the mobile computing device 2050. Such sound can include sound from voice telephone calls, can include recorded sound (e.g., voice messages, music files, etc.) and can also include sound generated by applications operating on the mobile computing device 2050.

The mobile computing device 2050 can be implemented in a number of different forms, as shown in the figure. For example, it can be implemented as a cellular telephone 2080. It can also be implemented as part of a smart-phone 2082, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A system comprising:
a bed; and
a controller operably connected to the bed, the controller comprising a processor and a computer-readable memory, the controller configured to:
receive, from one or more sensors, one or more different types of sleep data, the one or more different types of sleep data including data that is representative of historic sleep times and historic wake times for a user;
determine, based on the data that is representative of historic sleep times and historic wake times for the user, a sleep regularity factor for the user and a chronotype of the user;
access, a machine learning model that is trained to determine a sleep onset time for the user, the machine learning model being trained based on (i) the one or more different types of sleep data including data that is representative of historic sleep times and historic wake time for the user, (ii) the sleep regularity factor of the user, and (iii) the chronotype of the user;
determine, based on an output of the machine learning model, a sleep onset time for the user;
responsive to determining a sleep onset time for the user, determine a target time to communicate a bedtime reminder notification to the user; and
responsive to determining a target time to communicate a bedtime reminder notification to the user, communicate the bedtime reminder notification to the user.

2. The system of claim 1, wherein determining the target time to communicate the bedtime reminder notification to the user comprises accessing a machine learning model that is trained to determine a target time to communicate a bedtime reminder notification to the user.

3. The system of claim 1, wherein determining the target time to communicate the bedtime reminder notification to the user comprises accessing a look-up table of sleep onset prediction ranges.

4. The system of claim 1, wherein the controller is configured to communicate the bedtime reminder notification to the user by communicating an electronic message to a user device of the user.

5. The system of claim 1, wherein the controller is configured to communicate the bedtime reminder notification to the user by communicating a push notification through a sleep application on a user device of the user.

6. The system of claim 1, wherein the one or more sensors comprise a temperature sensor and wherein the one or more types of data include temperature data.

7. The system of claim 1, wherein the one or more sensors comprise a pressure sensor and wherein the one or more types of data include pressure data.

8. The system of claim 1, wherein the controller is further configured to:
receive additional sensor data from the one or more sensors;
based on receiving additional sensor data from the one or more sensors, determine whether the user is in the bed; and
based on determining that the user is not in the bed, communicate a second notification to the user, wherein the second notification is a reminder to the user to go to bed.

9. The system of claim 1, wherein the controller is further configured to:
receive additional sensor data from the one or more sensors;
based on receiving additional sensor data from the one or more sensors, determine whether the user is in the bed;
based on determining that the user is in the bed, determine whether the user is awake; and
based on determining that the user is awake in bed, communicate a signal to adjust a parameter of the bed to a sleep preference, wherein the sleep preference is a setting of a parameter that is associated with a sleep onset time.

10. The system of claim 9, wherein communicating the signal to adjust a sleep preference of the user comprises adjusting a pressure of the bed, adjusting a temperature of bed, adjusting an ambient temperature of a room with the bed, or adjusting any other adjustable preference.

11. The system of claim 1, wherein determining the sleep regularity factor for the user comprises determining whether the sleep regularity for the user is regular or irregular based on historic sleep data collected over a specified period of past days.

12. The system of claim 1, wherein determining the chronotype of the user comprises:
determining whether the user is an early chronotype, an intermediate chronotype type or a late chronotype based on sleep onset time.

13. A system comprising:
a bed;
a controller connected to the bed; and
a server in communication with the controller, the server comprising a processor and a computer-readable memory, the server configured to:
receive data that is representative of historic sleep times and historic wake times for a user of the bed from the controller;
determine, based on the data that is representative of historic sleep times and historic wake times for the user, a sleep regularity factor for the user and a chronotype of the user;
train a machine learning model to determine a sleep onset time for the user based on the data that is representative of historic sleep time and historic wake times for the user;
use the machine learning model to determine the sleep onset time for the user;
responsive to determining a sleep onset time for the user, determine a target time to communicate a bedtime reminder notification to the user;
determine that the target time to communicate the bedtime reminder notification to the user is approaching;
based on determining that the target time to communicate the bedtime reminder to the user is approaching, determine whether the user is in the bed; and
based on determining that the user is not in the bed, communicate the bedtime reminder notification to the user.

14. The system of claim 13, wherein the server is configured to communicate the bedtime reminder notification to the user by communicating an electronic message to a user device of the user.

15. The system of claim 13, wherein the server is configured to communicate the bedtime reminder notification to the user by communicating a push notification through a sleep application on a user device of the user.

16. The system of claim 13, wherein determining the sleep regularity factor for the user comprises determining whether the sleep regularity for the user is regular or irregular based on historic sleep data collected over a specified period of past days.

17. The system of claim 13, wherein determining the chronotype of the user comprises:
determining whether the user is an early chronotype, an intermediate chronotype type or a late chronotype based on sleep onset time.

18. The system of claim 13, wherein the server is configured to determine the target time to communicate a bedtime reminder notification to the user using a machine learning module that is trained to identify the target time.

19. The system of claim 13, wherein the server is configured to determine the target time to communicate a bedtime reminder notification to the user by accessing a look-up table of sleep onset prediction ranges.

20. A system comprising:
a bed;
a controller connected to the bed; and
a server in communication with the controller, the server comprising a processor and a computer-readable memory, the server configured to:
receive data that is representative of historic sleep times and historic wake times for a user of the bed from the controller;
train a machine learning model to determine a sleep onset time for the user based on the data that is representative of historic sleep times and historic wake times for the user;
use the machine learning model to determine the sleep onset time for the user;
responsive to determining a sleep onset time for the user, determine a target time to communicate a bedtime reminder notification to the user;
determine that the target time to communicate the bedtime reminder notification to the user is approaching;
based on determining that the target time to communicate the bedtime reminder to the user is approaching, determine whether the user is in the bed;
based on determining that the user is in the bed, determine whether the user is awake; and
based on determining that the user is awake, communicate the bedtime reminder notification to the user.
